(19) United States
(12) Patent Application Publication
(10) Pub. No.: US 2026/0258325 A1
(43) Pub. Date: Sep. 3, 2026

(54) BIODEGRADABLE MICROCAPSULES COMPRISING BETA-1-4 NON-IONIC POLYSACCHARIDE

(71) Applicant: INTERNATIONAL FLAVORS & FRAGRANCES INC., New York, NY (US)

(72) Inventor: Sonia-Patricia STOICA, Hilversum (NL)

(21) Appl. No.: 18/878,510

(22) PCT Filed: Jul. 5, 2023
(86) PCT No.: PCT/US2023/026939

§ 371 Date: Dec. 23, 2024

(30) Foreign Application Priority Data
Jul. 6, 2022 (EP) 22183276.9

(51) Int. Cl. C11D 3/50; C11D 3/00; C11D 3/22; C11D 3/37; C11D 3/382

(52) U.S. Cl. CPC C11D 3/505; C11D 3/001; C11D 3/0068; C11D 3/222; C11D 3/3726; C11D 3/382

(57) ABSTRACT

This disclosure relates to a core-shell microcapsule slurry that includes (a) a core-shell microcapsule, wherein the core-shell microcapsule has a microcapsule core and a microcapsule shell encapsulating the microcapsule core, the microcapsule core comprises an active material, and the microcapsule shell comprises a self-condensed polyisocyanate and a beta-1-4 non-ionic polysaccharide; (b) a dispersant comprising a denatured protein, wherein the denatured protein comprises a denatured pea protein and/or a denatured whey protein; and (c) a hydrocolloid comprising gum Arabic; wherein the microcapsule shell is characterized by a rupture force of at least 100 μN. This disclosure also relates to a process of producing such core-shell microcapsule slurry. This disclosure also relates to a consumer product containing such core-shell microcapsule slurry.

### CROSS-REFERENCE TO RELATED APPLICATIONS

This application claims priority of European Patent Application No. EP22183276.9 filed on Jul. 6, 2022, the disclosure of which is incorporated herein by reference in its entirety for all purposes.

### FIELD OF THE DISCLOSURE

The present disclosure relates to a biodegradable core-shell microcapsule slurry. Particularly, the microcapsule shell comprises a self-condensed polyisocyanate and a beta-1-4 non-ionic polysaccharide (e.g., xyloglucan). The present disclosure also relates to a process of producing such core-shell microcapsule slurry. The present disclosure also relates to a consumer product containing such core-shell microcapsule slurry.

### BACKGROUND OF THE DISCLOSURE

Microcapsules are useful in a variety of applications where there is a need to deliver, apply, or release a fragrance or other active material in a time-delayed and controlled manner.

Conventional microcapsules each have a polymeric shell encapsulating an active material in a microcapsule core. The polymeric shell is typically formed via an interfacial polymerization reaction, namely, a polymerization that occurs at an interface between an aqueous phase and an oil phase. These microcapsules have been developed to provide good performance in various consumer products such as laundry detergents. See, e.g., U.S. Pat. Nos. 7,491,687, 6,045,835, US2014/0287008, and WO2015/023961. Polyurea microcapsules have been developed for delivering fragrances. Their preparation involves the polymerization reaction between wall-forming materials, e.g., a polyisocyanate and a polyamine. During the polymerization reaction, the polyisocyanate can react with many fragrance ingredients such as primary alcohols contained in a fragrance accord. The other wall-forming material polyamine is also reactive towards aldehyde fragrance ingredients. Primary alcohols and aldehydes are common ingredients in many fragrance accords. Such fragrance ingredients are not suitable to be encapsulated by conventional microcapsules. In addition, fragrance ingredients having a high-water solubility are also unsuitable for conventional encapsulation as these ingredients tend to stay in the aqueous phase instead of being encapsulated in the microcapsule oil core. Challenges remain in encapsulating fragrances and other active materials without losing reactive and/or water-soluble ingredients.

Methods to incorporate biodegradable polymers into microcapsule compositions have been described. For example, U.S. Pat. No. 10,034,819B2 and US2019/0240124A1 teach microcapsules with an inner shell and outer shell, wherein the outer shell is produced by complex coacervation of first polyelectrolyte such as gelatin and a second polyelectrolyte such as carboxymethyl cellulose, sodium carboxymethyl guar gum, xanthan gum and plant gums.

Similarly, EP2588066B1 describes a coacervated capsule prepared with a coating layer composed of a protein, and optionally a non-protein polymer. Further, EP2811846B1 describes the use of protein aggregates as an interface layer around a hydrophobic substance. EP1855544B2 teaches the use of the encapsulation of an active ingredient in a matrix composed of 0.5-95 wt % of anionic polysaccharides and 0.5-95 wt % of peptides having a molecular mass within the range of 0.3-12 kDa. EP3746217A1 and WO2020/195132A1 describe the preparation of core-shell microcapsules by cross-linking a protein into the wall of the microcapsule. U.S. Pat. No. 10,166,196B2 discloses an agglomeration of primary microcapsules composed of a primary shell and outer shell, wherein the outer shell is the primary shell and outer shell are products of a complex coacervation reaction of a first protein such as a pea or soy protein and a second polymer such as an agar, gellan gum, gum arabic, casein, cereal prolamine, pectin, alginate, carrageenan, xanthan gum, canola protein, dilutan gum, locus bean gum, or welan gum.

Other attempts propose using xyloglucan as deposition polymer grafted onto polyurea or melamine formaldehyde microcapsules, mainly to enhanced deposition on clothing. For instance, WO2008/145547A1 discloses a process for attachment of a non-ionic deposition polymer, substantive to textiles, to core shell particles. Example 8 provides for the attachment of both locust bean gum and xyloglucan non-ionic deposition polymers to microcapsules by use of various addition polymers. Also, there is no mention of the use of biodegradable protein for capsule shell.

WO2012/007438A1 discloses a benefit agent containing particle comprising a multi layered shell in which the outer shell may be a polyurea with a deposition polysaccharide polymer (e.g., xyloglucan) exterior to the shell (see claim 4 and page 28-30). The deposition aid is grafted onto the particles via stirring with heat at 80° C. in presence of ascorbic acid and methyl acrylate.

WO2012/038144A1 discloses the attachment of xyloglucan deposition agent via polyvinylacetate formulations to preformed melamine formaldehyde perfume microcapsules, to enhance deposition on clothing even in the presence of mannanase (see example 3).

WO2016/177607A1 discloses polyurea microcapsules containing a benefit agent (e.g., fragrance) inside a polyurea shell that is characterized by a xyloglucan deposition polymer grafted onto it, which aids to reduce agglomeration of the microcapsules for improved dispersion in surfactant containing products. The xyloglucan deposition polymer is added at various time points (7 mins, 15 mins, 30 mins, 45 mins or 60 mins) after the encapsulation process had started, and before the curing step (see Example 1). There is also no mention of the use of plant protein, or specifically pea protein, for the capsule shell.

WO2007/062833A1 discloses use of polyxyloglucan as uncharged polysaccharide material onto a melamine formaldehyde as shell material of core shell polymer particles comprising a benefit agent (e.g., perfume). There is also no mention of the use of plant or pea protein for capsule shell.

These existing solutions still have limitations and do not adequately teach how to overcome the above-mentioned problems. Accordingly, there is a need to develop a microcapsule composition suitable for encapsulating active materials having ingredients that are sustainable and biodegradable.

### BRIEF SUMMARY OF THE DISCLOSURE

The present disclosure provides a core-shell microcapsule slurry. The core-shell microcapsule slurry comprises: (a) a core-shell microcapsule, wherein the core-shell microcapsule has a microcapsule core and a microcapsule shell encapsulating the microcapsule core, the microcapsule core comprises an active material, and the microcapsule shell comprises a self-condensed polyisocyanate and a beta-1-4 non-ionic polysaccharide; (b) a dispersant comprising a denatured protein, wherein the denatured protein comprises a denatured pea protein and/or a denatured whey protein; and (c) a hydrocolloid comprising gum Arabic; wherein the microcapsule shell is characterized by a rupture force of at least 100 μN.

The present disclosure also provides a process for producing a core-shell microcapsule slurry. The process comprises: (a) providing an aqueous phase comprising a denatured protein and gum Arabic, wherein the denatured protein comprises a denatured pea protein and/or a denatured whey protein; (b) providing an oil phase comprising an active material and a polyisocyanate; (c) emulsifying the oil phase with the aqueous phase to form an emulsion; (d) adding all of a beta-1-4 non-ionic polysaccharide to the emulsion within 5 minutes after commencement of the emulsifying step (c) to form a microcapsule slurry comprising core-shell microcapsules; and (e) curing the shell of the microcapsules at a temperature in the range of from 40° C. to 90° C. The present disclosure also provides a core-shell microcapsule slurry obtainable by such process.

### BRIEF DESCRIPTION OF THE FIGURES

Embodiments are illustrated in the accompanying figures to improve understanding of concepts as presented herein.

FIG. 1 shows sensory performance evaluations of Microcapsules 1-4 (prepared with the addition of xyloglucan at different times) compared to Comparative Microcapsule 14 (no xyloglucan) dosed over the side in powder detergent and hand washed.

FIG. 2 shows sensory performance evaluations of Microcapsules 1 and 7 dosed over the side in powder detergent and hand washed.

FIG. 3 shows sensory performance evaluations of Microcapsule 1 (made using denatured pea protein as dispersant) compared to Microcapsules 10-12 (made using modified starch as dispersant) and Microcapsule 13 (commercial melamine formaldehyde microcapsule). The Microcapsules were sprayed to powder detergent and washed in a hand wash protocol.

FIG. 4 shows sensory performance evaluations of Microcapsules 8 and 9 (comprising xyloglucan) compared to Comparative Microcapsule 14 (no xyloglucan) after spraying to powdered detergent and evaluated in a hand wash application.

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. For example, when a range of “1 to 10” is recited, the recited range should be construed as including ranges “1 to 8”, “3 to 10”, “2 to 7”, “1.5 to 6”, “3.4 to 7.8”, “1 to 2 and 7-10”, “2 to 4 and 6 to 9”, “1 to 3.6 and 7.2 to 8.9”, “1-5 and 10”, “2 and 8 to 10”, “1.5-4 and 8”, and the like.

The present disclosure illustratively described herein suitably may be practiced in the absence of any element or elements, limitation or limitations that are not specifically disclosed herein. While compositions and methods are described herein in terms of “comprising” various components or steps, the compositions and methods also can “consist essentially of” or “consist of” the various components or steps, unless stated otherwise.

All parts, percentages and proportions referred to herein and in the claims are by weight unless otherwise indicated.

The values and dimensions disclosed herein are not to be understood as being strictly limited to the exact numerical values recited. Instead, unless otherwise specified, each such value is intended to mean both the recited value and a functionally equivalent range surrounding that value. For example, a value disclosed as “50%” is intended to mean “about 50%.”

Before addressing details of embodiments described below, some terms are defined or clarified.

The terms “obtainable” and “obtained” can be used interchangeably in this disclosure and do not mean to indicate that, e.g., a product must be obtained by, e.g., the sequence of steps following the term “obtained” though such a limited understanding is always included by the terms as a preferred aspect of the present disclosure.

The term “rupture force”, as used herein, means the force required to rupture the microcapsules. It can be measured according to the method described in the Section “Method for Measuring the Rupture Force” of this disclosure.

The term “microcapsule slurry”, as used herein, means an aqueous suspension of the biodegradable core-shell microcapsule. In some embodiments, the biodegradable core-shell microcapsule product produced in accordance with the methods and examples described in the present disclosure is in the form of a microcapsule slurry. The microcapsule slurry may be used directly in a consumer product. The microcapsule slurry may also be washed, coated, dried (e.g., spray-dried) and/or combined with one or more other microcapsules, active materials, and/or carrier materials.

The term “self-condensed polyisocyanate”, as used herein, means the polyurea formed by the self-polymerization of polyisocyanate in the presence of water. A person skilled in the art appreciates that isocyanate can react with water to form amine which can further react with isocyanate to form urea linkage. Accordingly, polyisocyanate can self-polymerize in the presence of water to form polyurea.

As used herein, the terms “capsule”, “microcapsule” and “core-shell microcapsule” are used interchangeably and refer to a substantially spherical structure having a well-defined core and a well-defined envelope or wall or shell. The “core” comprises an active material or material submitted to microencapsulation. The terms “wall” and “shell” are used interchangeably to denote the structure formed by the microencapsulating polymer surrounding the active material core being microencapsulated.

As used herein, the term “w/w” means weight by weight and the term “w/v” means weight per volume. As used herein, the term “wt %” means percentage by weight.

As used herein, the terms “g”, “mg” and “g” refer to “gram”, “milligram” and “microgram” respectively. The terms “L”, “mL” and “L” refer to “liter”, “milliliter” and “microliter” respectively. The terms “cm”, “mm” and “μm” refer to “centimeter”, “millimeter” and “micrometer” respectively. The terms “mN” and “N” refer to “millinewton” and “micronewton” respectively.

### Polyisocyanate

As used herein, the terms “multifunctional isocyanate”, “polyfunctional isocyanate” and “polyisocyanate” can be used interchangeably and refer to a compound having two or more isocyanate (—NCO) groups. Polyisocyanates can be aromatic, aliphatic, linear, branched, or cyclic. In some embodiments, the polyisocyanate contains, on average, 2 to 4 isocyanate groups. In some embodiments, the polyisocyanate contains at least three isocyanate functional groups. In some embodiments, the polyisocyanate is water insoluble. In certain aspects, the polyisocyanate is an oligomeric polyisocyanate obtained from hexamethylene diisocyanate (HDI), which is a monomeric diisocyanate. In certain aspects, the polyisocyanate is an oligomeric polyisocyanate having a biuret, isocyanurate, allophanate, uretdione and/or oligomeric HDI structure. Exemplary polyisocyanates are sold under the tradenames TAKENATE® (e.g., TAKENATE® D-110N; Mitsui Chemicals), DESMODUR® (Covestro), BAYHYDUR® (Covestro), and LUPRANATE® (BASF).

In some embodiments, the polyisocyanate is an aromatic polyisocyanate. Desirably, the aromatic polyisocyanate includes a phenyl, tolyl, xylyl, naphthyl or diphenyl moiety as the aromatic component. In some embodiments, the aromatic polyisocyanate is selected from the group consisting of polyisocyanurate of toluene diisocyanate, trimethylol propane-adduct of toluene diisocyanate, trimethylol propane-adduct of xylylene diisocyanate, and mixtures thereof.

In some embodiments, the aromatic polyisocyanate has the structural formula shown below, and includes structural isomers thereof

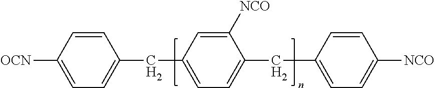

wherein n can vary from zero to a desired number (e.g., 0-50, 0-20, 0-10, or 0-6). Preferably, the number of n is limited to less than 6. The polyisocyanate may also be a mixture of polyisocyanates where the value of n can vary from 0 to 6. In the case where the polyisocyanate is a mixture of various polyisocyanates, the average value of n preferably falls in between 0.5 and 1.5.

In some embodiments, the aromatic polyisocyanate has the structural formula shown below, and includes structural isomers thereof

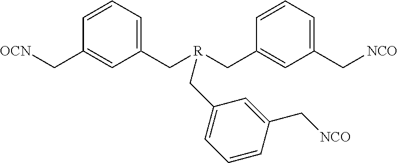

wherein R can be a C₁-C₁₀ alkyl, C₁-C₁₀ ester, or an isocyanurate. Representative polyisocyanates having this structure are sold under the trademarks TAKENATE® D-110N (Mitsui), DESMODUR® L75 (Covestro), and DESMODUR® IL (Covestro).

Trimethylol propane-adduct of xylylene diisocyanate has the structural formula shown below:

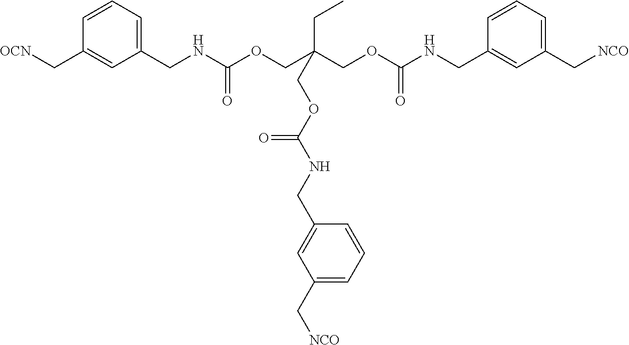

In some embodiments, the aromatic polyisocyanate is selected from the group consisting of 1,5-naphthylene diisocyanate, 4,4′-diphenylmethane diisocyanate (MDI), hydrogenated MDI (H12MDI), xylylene diisocyanate (XDI), tetramethylxylol diisocyanate (TMXDI), 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate, the isomers of tolylene diisocyanate (TDI), 4,4′-diisocyanatophenylperfluoroethane, phthalic acid bisisocyanatoethyl ester, aromatic polyisocyanates with reactive halogen atoms, and mixtures thereof. In some embodiments, the aromatic polyisocyanate with reactive halogen atom is selected from the group consisting of 1-chloromethylphenyl 2,4-diisocyanate, 1-bromomethyl-phenyl 2,6-diisocyanate, 3,3-bischloromethyl ether 4,4′-diphenyldiisocyanate, and mixtures thereof.

In some embodiments, the polyisocyanate is an aliphatic polyisocyanate. In some embodiments, the aliphatic polyisocyanate is selected from the group consisting of trimer of hexamethylene diisocyanate, trimer of isophorone diisocyanate, biuret of hexamethylene diisocyanate, and mixtures thereof. In some embodiments, the aliphatic polyisocyanate is selected from the group consisting of 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane, chlorinated aliphatic diisocyanates, brominated aliphatic diisocyanates, phosphorus-containing aliphatic diisocyanates, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, and mixtures thereof. In some embodiments, the polyisocyanate comprises a sulfur-containing polyisocyanate which can be obtained, for example, by reacting hexamethylene diisocyanate with thiodiglycol or dihydroxydihexyl sulfide. In some embodiments, the polyisocyanate is an aliphatic diisocyanate selected from the group consisting of trimethylhexamethylene diisocyanate, 1,4-diisocyanatobutane, 1,2-diisocyanatododecane, dimer fatty acid diisocyanate, and mixtures thereof.

In some embodiments, the weight average molecular weight of the polyisocyanate ranges from 250 Da to 1000 Da, or from 275 Da to 500 Da. In some embodiments, the polyisocyanate used in the preparation of the shell of the microcapsule is a single polyisocyanate. In other embodiments, the polyisocyanate is a mixture of polyisocyanates. In some embodiments, the mixture of polyisocyanates includes an aliphatic polyisocyanate and an aromatic polyisocyanate. In some embodiments, the polyisocyanate is a mixture of a biuret of hexamethylene diisocyanate and a trimethylol propane-adduct of xylylene diisocyanate. In some embodiments, the polyisocyanate is an aliphatic polyisocyanate or a combination of aliphatic polyisocyanates, free of any aromatic polyisocyanate. In some embodiments, the polyisocyanate is trimethylol propane-adduct of xylylene diisocyanate, and the shell of the microcapsule comprises a self-condensed trimethylol propane-adduct of xylylene diisocyanate.

### Active Material

The core of the microcapsule comprises an active material encapsulated therein. In some aspects, the active material has a log P value (partition coefficient) of less than 2. In certain aspects, the microcapsule comprises at least two, three, four or more active materials in the core. Active materials that may be encapsulated in the core-shell microcapsule of this disclosure include, but are not limited to, fragrances, flavors, agricultural actives, pesticides, insecticides, herbicides, fungicides, pharmaceutical actives, nutraceutical actives, animal nutrition actives, food actives, microbio actives, malodor counteractants, and/or cosmetic actives. In some embodiments, the active material is selected from the group consisting of fragrance, pro-fragrance, malodor counteractive agent, and combinations thereof. In some embodiments, the active material comprises a fragrance, preferably a fragrance comprising at least one, at least two, at least three, at least four, at least five, at least six, at least seven, at least eight, at least nine or at least ten High Performance fragrance ingredients selected from the group consisting of Ultra High-Impact fragrance ingredients as listed in Table 1 and High-Impact fragrance ingredients as listed in Table 2.

TABLE 1
Ultra High-Impact Fragrance Ingredients

| No. | Trade Name | CAS |
|---|---|---|
| 1. | ALD C-11 INTRELEVEN (TT) PRG | 143-14-6 |
| 2. | ALD C-6 TOCO | 66-25-1 |
| 3. | Musk Indenofuran (2,2,6,6,7,8,8- | 476332-65-7, |
| | heptamethyldecahydro-2H- | 647828-16-8 |
| | indeno[4,5-b]furan) | |
| 4. | AMBERMOR EX | 6790-58-5 |
| 5. | AMBERMORKETAL | 57345-19-4 |
| 6. | AMBROCENIDE CRYST | 211299-54-6 |
| 7. | CALONE | 28940-11-6 |
| 8. | CITRYLAL BHT | 90480-35-6, |
| | | 147060-73-9 |
| 9. | CLONAL | 2437-25-4 |
| 10. | CREOSOL #340 | 93-51-6 |
| 11. | CRESYL ACET PARA COEUR | 140-39-6 |
| 12. | DECENAL,CIS-4 | 21662-09-9 |
| 13. | DODECENAL TRANS-2 TOCO | 20407-84-5 |
| 14. | DUPICAL TOCO | 30168-23-1 |
| 15. | DYNASCONE BHT | 56973-85-4 |
| 16. | FLORAL SUPER | 71077-31-1 |
| 17. | FRAGARONE | 16957-70-3 |
| 18. | GALBASCONE ALPHA 95 PRG | 56973-85-4 |
| 19. | GALBASCONE PRG TOCO | 56973-85-4, |
| | | 56973-84-3 |
| 20. | ISO BUTYL QUINOLINE | 67634-06-4 |
| 21. | ISO BUTYL THIAZOLE | 18640-74-9 |
| 22. | JAMUNATE | 7605-52-9 |
| 23. | KOUMALACTONE 10 PCT TEC FIRM | 77-93-0 |
| 24. | MANGONE CSM | 38462-22-5 |
| 25. | MELOZONE | 30772-79-3 |
| 26. | METH HEPTIN CARBONATE | 111-12-6 |
| 27. | METH LAITONE 10 PCT DPG | 110-98-5 |
| 28. | METH PHEN ETH ETHER | 3558-60-9 |
| 29. | NONADIENAL,2-TR-6-CIS TOCO | 557-48-2 |
| 30. | NONENOL,CIS-6 TOCO | 35854-86-5 |
| 31. | OPALENE TOCO | 174155-47-6 |
| 32. | ORENYLE | 29127-83-1 |
| 33. | ORRIS ALD TOCO | 60784-31-8 |
| 34. | OXANE 50 PCT TEC | 59323-76-1, |
| | | 59324-17-3 |
| 35. | PASSION FRUIT CMPD | 59323-76-1 |
| 36. | PHARAONE 10 PCT DPG | 110-98-5 |
| 37. | PYRAZINE 044 (METH) | 109-08-0 |
| 38. | ROSE OXIDE “L” TOCO | 16409-43-1 |
| 39. | ROSYRANE SUPER | 60335-71-9 |
| 40. | SACRAZOLE-018 | 137-00-8 |
| 41. | THIAZOLE (2-ISO PROP 4-METH) | 15679-13-7 |
| 42. | TRIDECENE-2-NITRILE | 22629-49-8 |
| 43. | TROPICALIA TOCO | 10138-32-6 |
| 44. | VIONIL NEAT | 67019-89-0 |
| 45. | HEALINGWOOD ¹ | Natural Oil |
| 46. | VIOLET LEAF ABS EGYPT LMR ¹ | Natural Oil |

¹ Available from International Flavors & Fragrances Inc.

TABLE 2
High-Impact Fragrance Ingredients

| No. | Trade Name | CAS |
|---|---|---|
| 1. | ACETOPHENONE | 98-86-2 |
| 2. | AGRUNITRILE | 51566-62-2 |
| 3. | ALD AA TRIPLAL BHT | 68039-49-6 |
| 4. | ALD C-10 | 112-31-2 |
| 5. | ALD C-11 MOA BHT | 19009-56-4 |
| 6. | ALD C-11 ULENIC TOCO | 112-45-8 |
| 7. | ALD C-11 UNDECYLIC TOCO | 112-44-7 |
| 8. | ALD C-12 LAURIC TOCO | 112-54-9 |
| 9. | ALD C-12 MNA TOCO | 110-41-8 |
| 10. | ALD C-16 STRAWB#2 | 77-83-8 |
| 11. | ALD C-18 | 104-61-0 |
| 12. | ALD C-8 TOCO | 124-13-0 |
| 13. | ALD C-9 TOCO | 124-19-6 |
| 14. | AMBERTONIC | 1392325-86-8 |
| 15. | AMBRETTOLIDE | 28645-51-4 |
| 16. | AQUAFLORA TOCO | 1339119-15-1 |
| 17. | BENZALD FFC | 100-52-7 |
| 18. | CASHMERAN | 33704-61-9 |
| 19. | CEDRAMBER | 67874-81-1 |
| 20. | CITRAL NEW | 5392-40-5 |
| 21. | COOLWOOD | 1340502-69-3 |
| 22. | CRESOL PARA EXTRA | 106-44-5 |
| 23. | CRISTALFIZZ | 1093653-57-6 |
| 24. | CYCLAPROP | 68912-13-0 |
| 25. | CYCLEMAX | 7775-00-0 |
| 26. | DAMASCENONE TOCO | 23696-85-7 |
| 27. | DAMASCONE DELTA | 71048-82-3 |
| 28. | DELPHONE | 4819-67-4 |
| 29. | DIPHEN OXIDE | 101-84-8 |
| 30. | DORIFFOX | 149713-23-5 |
| 31. | ETH ACETO ACET | 141-97-9 |
| 32. | ETH CAPROATE | 123-66-0 |
| 33. | ETH PHEN GLYC | 121-39-1 |
| 34. | ETH SAL | 118-61-6 |
| 35. | ETH-2-METH BUTY | 7452-79-1 |
| 36. | EUCALYPTOL USP | 470-82-6 |
| 37. | FLORHYDRAL TOCO (ELINCS) | 125109-85-5 |
| 38. | FRUITATE (ELINCS) | 129520-41-8 |
| 39. | HEXADECANOLIDE BHT | 109-29-5 |
| 40. | HEXENYL ISOBUTY,CIS-3 | 41519-23-7 |
| | (VERDURAL B) | |
| 41. | INDOLE | 120-72-9 |
| 42. | IONONE ALPHA TOCO | 127-41-3 |
| 43. | IRONE V BHT | 79-69-6 |
| 44. | ISO CYCLO CITRAL TOCO | 1423-46-7 |
| 45. | LACTONE OF CIS JASMONE TOCO | 70851-61-5 |
| 46. | LEMONILE | 61792-11-8 |
| 47. | MELONAL TOCO | 106-72-9 |
| 48. | MENTHONE 85 | 89-80-5 |
| 49. | METH BENZOATE | 93-58-3 |
| 50. | METH CINNAMATE TOCO | 103-26-4 |
| 51. | METH DH JASMONATE | 24851-98-7 |
| 52. | METH HEPTYL KETONE | 821-55-6 |
| 53. | METH JASMONATE TOCO | 39924-52-2 |
| 54. | METH OCTIN CARBONATE | 111-80-8 |
| 55. | METH PARA CRESOL | 104-93-8 |
| 56. | METH TUBERATE RD | 35205-76-6 |
| 57. | MUSCEMOR (ELINCS) | 82356-51-2 |
| 58. | MYRAC ALD BHT | 52475-89-5 |
| 59. | NECTARYL LRG 1371 ELINCS | 95962-14-4 |
| 60. | OCEANOL | 33662-58-7 |
| 61. | OPERANIDE (ELINCS) | 823178-41-2 |
| 62. | PHEN ETH ACET | 103-45-7 |
| 63. | PINEAPPLE CMPD | 3658-77-3 |
| 64. | PINO ACETALD TOCO | 33885-51-7 |
| 65. | ROSALVA | 13019-22-2 |
| 66. | ROSE OXIDE TOCO | 16409-43-1 |
| 67. | ROSETHYL | 64988-06-3 |
| 68. | SAFRALEINE | 54440-17-4 |
| 69. | SINFONIDE | 1315251-11-6 |
| 70. | STARFLEUR TOCO | 1254940-85-6 |
| 71. | SYLVONIC | 98-55-5 |
| 72. | TERPINOLENE P UB BHT | 586-62-9 |
| 73. | TOFFEE LACTONE 2067 | 705-86-2, |
| | | 706-14-9 |
| 74. | TOFFEETONE FOR NON TSCA USE ONLY | 13537-82-1 |
| 75. | TONKALACTONE | 54491-17-7 |
| 76. | TRIFERNAL BHT | 16251-77-7 |
| 77. | ULTRAVANIL Q COLIPA | 2563-07-7 |
| 78. | UNDECALACTONE,DELTA | 710-04-3 |
| 79. | UNDECAVERTOL TOCO | 81782-77-6 |
| 80. | VANITROPE | 94-86-0 |
| 81. | VARAMOL-106 | 7786-61-0 |
| 82. | VELTOL PLUS | 4940-11-8 |
| 83. | VERAMOSS | 4707-47-5 |
| 84. | VERIDIAN | 811412-48-3 |
| 85. | VERTOLIFF TOCO | 36635-35-5 |
| 86. | VERTONIC | 1945993-03-2 |
| 87. | VETIVER ACET HAITI TOCO BLO | 84082-84-8 |
| 88. | YARA | 93-04-9 |
| 89. | YLANGANATE | 89-71-4 |
| 90. | ARMOISE OIL PURE ¹ | Natural oil |
| 91. | BLKCURRANT BUD ABS BURGUNDY LMR | Natural oil |
| | FOR LIFE ¹ | |
| 92. | CHAMOMILE OIL ENG ³ | Natural oil |
| 93. | CHAMOMILE OIL ROMAN LMR SFO ¹ | Natural oil |
| 94. | CINNAMON BARK ESSENTIAL LMR ¹ | Natural oil |
| 95. | DAVANA OIL LMR FLG SFO ¹ | Natural oil |
| 96. | EUGENOL NAT EX CLOVE LEAF OIL | Natural oil |
| 97. | JASMIN ABS EGYPT LMR ¹ | Natural oil |
| 98. | ORANGE FLOWER WATER ABS TUNISIA | Natural oil |
| | LMR ¹ | |
| 99. | OSMANTHUS ABS LMR | Natural oil |
| 100. | PATCHOULI OIL LIGHT BLO ² | Natural oil |
| 101. | PEPPER PINK CO2 LMR ¹ | Natural oil |
| 102. | ROSE ABS DAMASCENA PURE BLO ¹ | Natural oil |
| 103. | SINENSAL NATURAL 20 EX ORANGE ³ | Natural oil |
| 104. | THYME OIL WHITE SPAIN BLO ¹ | Natural oil |

¹ Available from International Flavors & Fragrances Inc (New York).
² Available from TRIPPER PTE Ltd. (Indonesia).
³ Available from TREATT & CO. Ltd. (United Kingdom).

In addition to the fragrance ingredients listed in Tables 1 and 2, the fragrance may further comprise at least one additional fragrance ingredient. Preferably, the fragrance may further comprise 1, 2, 3, 4, 5, 6, 7, 8, 9, 10, 15, 20, 25, 30, 35, 40 or more additional fragrance ingredients, which are not listed in Tables 1 and 2. Non-limiting examples of such additional fragrance ingredients include those described in US 2018/0325786 A1, U.S. Pat. Nos. 4,534,891, 5,112,688, and 5,145,842. Other suitable active materials that can be encapsulated include those listed in WO 2016/049456, pages 38-50.

In some embodiments, the additional fragrance ingredients, when combined with one or more fragrance ingredients of Tables 1 and 2, constitute the total fragrance composition. In this respect, the balance of the 100 wt % relative to the total weight of the fragrance component is made up of one or more Ultra High-Impact and High-Impact fragrance ingredients of Tables 1 and 2 and one or more additional fragrance ingredients.

It has been surprisingly discovered that a fragrance that includes certain types of Ultra High-Impact and High-Impact fragrance ingredients results in High Performance fragrance ingredients for use in fabric care compositions, preferably fabric conditioner, that improves fragrance profile and/or performance of the system. As used herein, the term “fragrance profile” means the description of how the fragrance is perceived by the human nose at any moment in time. The fragrance profile may change over time. It is a result of the combination of the base, heart and top notes, if present, of a fragrance. Base notes are characterized by providing animalic, woody, sweet, amber or musky characters, and not being very volatile. Heart notes are associated with desirable characters such as floral characters (e.g., jasmin, rose), fruity, marine, aromatic or spicy characters. The “top or head notes” provide citrusy, green, light, or fresh characters and tend to evaporate quickly due to their high volatility. A fragrance profile is composed of two characteristics: “intensity” and “character”. The “intensity” relates to the perceived strength whilst “character” refers to the odor impression or quality of the perfume, i.e., fresh, clean, etc.

In some embodiments, the active material component (e.g., fragrance) of the core-shell microcapsule is present at a level of between 1 wt % and 35 wt %, preferably between 15 wt % and 35 wt %, or more preferably between 20 wt % and 35 wt %, relative to the weight of the microcapsule slurry. When the fragrance comprises a combination of the Ultra High-Impact fragrance ingredients and the High-Impact fragrance ingredients listed in Tables 1 and 2, the fragrance can be used at a significantly reduced dosage (e.g., at least 2-, 5- to 10-fold lower levels) as compared to a standard fragrance that does not comprise the Ultra High-Impact fragrance ingredients and High-Impact fragrance ingredients listed in Tables 1 and 2. In particular, a fragrance comprising at least five High Performance fragrance ingredients comprising Ultra High-Impact fragrance can be used at a dosage level of <1 wt % (e.g., 0.01 wt % to 1 wt %) relative to the total weight of the microcapsule slurry. In certain aspects, when the fragrance is a neat fragrance, an encapsulated fragrance or a combination thereof, the weight ratio of the Ultra High-Impact fragrance ingredients to the High-Impact fragrance ingredients is in the range of 1:0 to 1:19.

In some embodiments, the active material comprises agricultural active, pesticide, insecticide, herbicide, and/or fungicide. Encapsulation of agricultural actives, pesticides, insecticides, herbicides, and/or fungicides can increase their efficacy, extend their effective period and protect the environment. In some embodiments, the insecticide is an organophosphate insecticide. In some embodiments, the insecticide can be an organophosphate insecticide selected from the group consisting of acephate, azinphos-mehyl, chlorfenvinphos, chlorethoxyfos, chlorpyriphos-methyl, diazinon, dimethoate, disulfoton, ethoprophos, fenitrothion, fenthiom, fenamiphos, fosthiazate, malathion, methamidophos, methidathion, omethoate, oxydemeton-methyl, parathion, parathion-methyl, phorate, phosmet, profenofos, trichlorfon, and mixtures thereof. In some embodiments, the insecticide is selected from the group consisting of cypermethrin, bifenthrin, λ-cyhalothrin, and mixtures thereof. In some embodiments, the herbicide is selected from the group consisting of clomazone, acetochlor, pendimethalin, and mixtures thereof. In some embodiments, the fungicide is tebuconazole.

### Denatured Protein

A denatured protein is used in the process of this disclosure to produce a core-shell microcapsule slurry, and the denatured protein comprises a denatured pea protein and/or a denatured whey protein. Pea protein includes pea protein isolate, pea protein concentrate, or a combination thereof. Pea protein isolates and concentrates are generally understood to be composed of several proteins. For example, pea protein isolates and concentrates can include legumin, vicilin and convicilin proteins. The term “pea protein” is also intended to include a partially or completely modified pea protein. Individual pea protein component, such as legumin, vicilin, or convicilin, can also be used in the preparation of microcapsules of this disclosure.

The term “whey protein” refers to a protein fraction of milk which does not precipitate at the pH 4.6. The term “whey” encompasses whey derived from cheesemaking or casein manufacture and whey obtained from various membrane filtrations of milk, such as microfiltration, ultrafiltration, nanofiltration, reverse osmosis, diafiltration, chromatography, crystallization or a combination thereof. “Whey protein” is intended to include a whey protein isolate, a whey protein concentrate, or a combination thereof.

In some embodiments, the pea protein and/or the whey protein is isolated and optionally purified to homogeneity or near homogeneity, e.g., at least about 80%, about 85%, about 90%, about 92%, about 95%, about 97%, about 98%, or about 99% pure to the pea and/or whey protein. Preferably, the pea protein and/or the whey protein is denatured, preferably without causing gelation of the protein. Exemplary conditions for protein denaturation include, but are not limited to, exposure to heat or cold, changes in pH, exposure to denaturing agents such as detergents, urea, or other chaotropic agents, or mechanical stress including shear. In some aspects, the pea protein and/or the whey protein is partially denatured, e.g., at least 50%, 60%, 70%, 80% or 85% of the pea protein and/or the whey protein is denatured, based on the total weight of the pea protein and/or the whey protein. In other aspects, the pea protein and/or the whey protein is substantially or completely denatured, e.g., at least 90%, 95%, or 98% of the pea protein and/or the whey protein is denatured, based on the total weight of the pea protein and/or the whey protein. For example, when an 8% pea protein solution (w/v) is used, the solution can be treated at a temperature of 80° C. to 90° C. for 20 to 30 minutes (or preferably 85° C. for 25 minutes) to produce a substantially denatured pea protein.

In particular, it has been found that chaotropic agents are particularly useful in providing a denatured protein of use in the preparation of the microcapsules of the present disclosure. As is conventional in the art, a chaotropic agent is a compound which disrupts hydrogen bonding in aqueous solution, leading to increased entropy. Generally, this reduces hydrophobic effects which are essential for three dimensional structures of proteins. Chaotropes can be defined by having a positive chaotropic value, i.e., kJ kg⁻¹ mole on the Hallsworth Scale. Examples of chaotropicity values are, for example, CaCl₂)+92.2 kJ kg⁻¹, MgCl₂+54.0 kJ kg⁻¹, butanol+37.4 kJ kg⁻¹, guanidine hydrochloride+31.9 kJ kg⁻¹, and urea+16.6 kJ kg⁻¹. In certain aspects, the chaotropic agent is a guanidine salt, e.g., guanidine sulphate, guanidine carbonate, guanidine nitrate or guanidine chloride. In particular aspects, the pea protein and/or the whey protein is partially or completely denatured with guanidine carbonate.

### Beta-1-4 Non-Ionic Polysaccharide

The beta-1-4 non-ionic polysaccharide used in the preparation of the microcapsules of the present disclosure is a non-ionic polysaccharide with a linear backbone of beta-(1→4)-linked glucosyl residues, preferably decorated with a regular pattern of alpha-(1→6)-linked xylosyl residues, which are optionally extended with galactosyl, fucosyl, and/or arabinosyl residues. In certain aspects, the beta-1-4 non-ionic polysaccharide is hydrophilic. In particular aspects, the beta-1-4 non-ionic polysaccharide is xyloglucan. Beta-1-4 non-ionic polysaccharides of use in this disclosure are known in the art and readily available from commercial sources.

### Microcapsule Formation Aids

Most microcapsule formation aids are used as dispersants (namely, emulsifiers or surfactants). They facilitate the formation of stable emulsions containing nano- or micro-sized oil drops to be encapsulated. Further, microcapsule formation aids improve the performance of the microcapsule by stabilizing capsules and/or their deposition to the target areas or releasing to the environment. The amount of these microcapsule formation aids is anywhere from about 0.1% to about 40% by weight of the microcapsule, more preferably from about 0.1% to about 10%, more preferably about 0.1% to about 5% by weight of the microcapsule.

Examples of microcapsule formation aids are polyvinyl pyrrolidone, polyvinyl alcohol, poly(styrene sulfonate), carboxymethyl cellulose, sodium salt of naphthalene sulfonate condensate, co-polymer of ethylene and maleic anhydride, an alginate, hyaluronic acid, poly(acrylic acid), carboxymethylcellulose, copolymers of acrylic acid and acrylamide, copolymer of acrylamide and acrylamidopropyltrimonium chloride, terpolymers (i.e., terpolymers of acrylic acid, acrylamide, and acrylamidopropyltrimonium chloride), partially or completely hydrolyzed polyvinyl acetate polymers (i.e., polyvinyl alcohol), or a combination thereof.

Other microcapsule formation aids include water-soluble salts of alkyl sulfates, alkyl ether sulfates, alkyl isothionates, alkyl carboxylates, alkyl sulfosuccinates, alkyl succinamates, alkyl sulfate salts such as sodium dodecyl sulfate, alkyl sarcosinates, alkyl derivatives of protein hydrolysates, acyl aspartates, alkyl or alkyl ether or alkylaryl ether phosphate esters, sodium dodecyl sulphate, phospholipids or lecithin, or soaps, sodium, potassium or ammonium stearate, oleate or palmitate, alkylarylsulfonic acid salts such as sodium dodecylbenzenesulfonate, sodium dialkylsulfosuccinates, dioctyl sulfosuccinate, sodium dilaurylsulfosuccinate, poly(styrene sulfonate) sodium salt, isobutylene-maleic anhydride copolymer, sodium alginate, cellulose sulfate and pectin, isobutylene-maleic anhydride copolymer, gum arabic, carrageenan, sodium alginate, pectic acid, tragacanth gum, almond gum and agar; semi-synthetic polymers such as sulfated cellulose, sulfated methylcellulose, carboxymethyl starch, phosphated starch, lignin sulfonic acid; and synthetic polymers such as maleic anhydride copolymers (including hydrolysates thereof), polyacrylic acid, polymethacrylic acid, acrylic acid butyl acrylate copolymer or crotonic acid homopolymers and copolymers, vinylbenzenesulfonic acid or 2-acrylamido-2-methylpropanesulfonic acid homopolymers and copolymers, and partial amide or partial ester of such polymers and copolymers, carboxymodified polyvinyl alcohol, sulfonic acid-modified polyvinyl alcohol and phosphoric acid-modified polyvinyl alcohol, phosphated or sulfated tristyrylphenol ethoxylates.

Commercially available surfactants include, but are not limited to, sulfonated naphthalene-formaldehyde condensates sold under the tradename MORWET® D425 (sodium salt of alkylnaphthalenesulfonate formaldehyde condensate, Akzo Nobel, Fort Worth, TX); partially hydrolyzed polyvinyl alcohols sold under the tradenames MOWIOL®, e.g., MOWIOL® 3-83 (Air Products), or SELVOL® 203 (Sekisui), or polyvinyl alcohols such as Ultalux FP, Ultalux FA, Ultalux AD, OKS-8089 (Sourus); ethylene oxide-propylene oxide block copolymers or poloxamers sold under the tradenames PLURONIC®, SYNPERONIC® or PLURACARE® materials (BASF); sulfonated polystyrenes sold under the tradename FLEXAN® II (Akzo Nobel); ethylene-maleic anhydride polymers sold under the tradename ZEMAC® (Vertellus Specialties Inc.); copolymer of acrylamide and acrylamidopropyltrimonium chloride sold under the tradename SALCARE® SC 60 (BASF); and polyquaternium series such as Polyquaternium 11 (“PQ11;” a copolymer of vinyl pyrrolidone and quaternized dimethylaminoethyl methacrylate; sold by BASF as Luviquat PQ11 AT 1). Surfactant MOWIOL® 3-83 has a viscosity of 2-4 mPa·S (e.g., 3 mPa·S), a degree of hydrolysis of 80-85% (e.g., 83%), an ester value of 170-210 mg KOH/g (e.g., 190 mg KOH/g), and a residual unhydrolyzed acetyl content of 13-18% (e.g., 15%). In certain aspects, the surfactant or emulsifier is a sulfonated polystyrene, e.g., the high molecular weight polystyrene sulfonate, sodium salt sold under the tradename FLEXAN® II.

In other aspects, the capsule formation aid is a processing aid such as a hydrocolloid, which improves the colloidal stability of the slurry against coagulation, sedimentation and creaming. The term “hydrocolloid” refers to a broad class of water-soluble or water-dispersible polymers having anionic, cationic, zwitterionic or non-ionic character. Hydrocolloids useful in the present disclosure include, but are not limited to, polycarbohydrates, such as starch, modified starch, dextrin, maltodextrin, and cellulose derivatives, and their quaternized forms; natural gums such as alginate esters, carrageenan, xanthan, agar-agar, pectins, pectic acid, gum arabic, gum tragacanth and gum karaya, guar gums and quaternized guar gums; gelatin, protein hydrolysates and their quaternized forms; synthetic polymers and copolymers, such as poly(vinyl pyrrolidone-co-vinyl acetate), poly(vinyl alcohol-co-vinyl acetate), poly((met)acrylic acid), poly(maleic acid), poly(alkyl(meth)acrylate-co-(meth)acrylic acid), poly(acrylic acid-co-maleic acid)copolymer, poly(alkyleneoxide), poly(vinylmethylether), poly(vinylether-co-maleic anhydride), and the like, as well as poly-(ethyleneimine), poly((meth)acrylamide), poly(alkyleneoxide-co-dimethylsiloxane), poly(amino dimethylsiloxane), Ultrez 20 (Acrylates/C10-30 Alkyl Acrylate Crosspolymer), cross-linked homopolymer of acrylic acid polymerized in a cyclohexane and ethyl acetate co-solvent system sold under the tradename CARBOPOL® Ultrez 30, acrylates copolymer sold under the tradename ACULYN® Excel (Acrylates Copolymer), crosslinked polyacrylic acid polymer sold under the tradename CARBOPOL® 981 (Carbomer), and the like, and their quaternized forms. In certain aspects, the microcapsule composition is prepared in the presence of gum arabic as a hydrocolloid.

The capsule formation aid can also be used in combination with carboxymethyl cellulose (“CMC”), polyvinylpyrrolidone, polyvinyl alcohol, alkylnaphthalenesulfonate formaldehyde condensates, and/or a surfactant during processing to facilitate capsule formation. Examples of surfactants that can be used in combination with the capsule formation aid include, but are not limited to, cetyl trimethyl ammonium chloride (CTAC), poloxamers sold under the tradenames PLURONIC® (e.g., PLURONIC® F127), PLURAFAC® (e.g., PLURAFAC® F127), or Miranet-N, saponins sold under the tradename Q-NATURALE® (National Starch Food Innovation); or a gum arabic such as Seyal or Senegal. In certain aspects, the CMC polymer has a molecular weight range between about 90,000 Daltons to 1,500,000 Daltons, preferably between about 250,000 Daltons to 750,000 Daltons and more preferably between 400,000 Daltons to 750,000 Daltons. The CMC polymer has a degree of substitution between about 0.1 to about 3, preferably between about 0.65 to about 1.4, and more preferably between about 0.8 to about 1.0. The CMC polymer is present in the capsule slurry at a level from about 0.1% to about 2% and preferably from about 0.3% to about 0.7%. in other aspects, polyvinylpyrrolidone used in this invention is a water-soluble polymer and has a molecular weight of 1,000 to 10,000,000. Suitable polyvinylpyrrolidone are polyvinylpyrrolidone K12, K15, K17, K25, K30, K60, K90, or a combination thereof. The amount of polyvinylpyrrolidone is 2-50%, 5-30%, or 10-25% by weight of the capsule delivery system. Commercially available alkylnaphthalenesulfonate formaldehyde condensates include MORWET® D-425, which is a sodium salt of naphthalene sulfonate condensate by Akzo Nobel, Fort Worth, TX.

The present disclosure provides a core-shell microcapsule slurry. The core-shell microcapsule slurry comprises: (a) a core-shell microcapsule, wherein the core-shell microcapsule has a microcapsule core and a microcapsule shell encapsulating the microcapsule core, the microcapsule core comprises an active material, and the microcapsule shell comprises a self-condensed polyisocyanate and a beta-1-4 non-ionic polysaccharide; (b) a dispersant comprising a denatured protein, wherein the denatured protein comprises a denatured pea protein and/or a denatured whey protein; and (c) a hydrocolloid comprising gum Arabic; wherein the microcapsule shell is characterized by a rupture force of at least 100 μN. In some embodiments, the beta-1-4 non-ionic polysaccharide comprises or is xyloglucan. In some embodiments, the polyisocyanate comprises or is an aromatic polyisocyanate. In some embodiments, the polyisocyanate comprises or is trimethylol propane-adduct of xylylene diisocyanate. In some embodiments, the denatured protein comprises or is a denatured pea protein. In some embodiments, the denatured protein comprises or is a denatured whey protein.

The microcapsule shell comprises, consists essentially of, or consists of a self-condensed polyisocyanate and a beta-1-4 non-ionic polysaccharide (e.g., xyloglucan). In some embodiments, the amount of the self-condensed polyisocyanate present in the microcapsule shell is in a range of from 0.1% to 10%, preferably from 0.1% to 8%, more preferably from 0.2% to 5%, and even more preferably from 1.5% to 3.5% or from 0.1% to 5%, all by weight based on the weight of the core-shell microcapsule slurry. In some embodiments, the amount of the self-condensed polyisocyanate is no more than 1%, 0.9%, 0.8%, 0.7%, 0.6%, 0.5%, 0.4%, 0.3%, or 0.2%, by weight based on the weight of the core-shell microcapsule slurry. In some embodiments, the amount of beta-1-4 non-ionic polysaccharide (e.g., xyloglucan) present in the microcapsule shell is in a range of from about 0.1 wt % to about 5 wt %, or from about 0.1 wt % to about 2 wt %, or from about 0.1 wt % to about 1 wt %, or from about 0.1 wt % to about 0.5 wt %, based on the weight of the microcapsule slurry. In some embodiments, the amount of beta-1-4 non-ionic polysaccharide (e.g., xyloglucan) present in the microcapsule shell is at least about 0.01 wt %, or at least about 0.02 wt %, or at least about 0.05 wt %, or at least about 0.1 wt %, or at least about 0.15 wt %, or at least about 0.2 wt %, based on the weight of the microcapsule slurry. In some embodiments, the amount of beta-1-4 non-ionic polysaccharide (e.g., xyloglucan) present in the microcapsule shell is no more than about 5 wt %, or no more than about 4 wt %, or no more than about 3 wt %, or no more than about 2 wt %, or no more than about 1 wt %, or no more than about 0.5 wt %, based on the weight of the microcapsule slurry. In some embodiments, the weight ratio of the beta-1-4 non-ionic polysaccharide (e.g., xyloglucan) to the denatured protein (e.g., the denatured pea protein and/or the denatured whey protein) is in a range of from 1:6 to 1:7.5. In some embodiments, the weight ratio of the beta-1-4 non-ionic polysaccharide (e.g., xyloglucan) to the microcapsule shell is in a range of from 1:3 to 1:5.

It has now been found that a polyisocyanate, such as trimethylol propane-adduct of xylylene diisocyanate, when reacted with water to form an amine group, can self-polymerize in the presence of a denatured protein (as dispersant) and form a wall material suitable for encapsulation of active materials. In some embodiments, the polyisocyanate does not crosslink or form covalent bond with the denatured protein. Rather, the denatured protein appears to function as a scaffold to facilitate the self-polymerization reaction of the polyisocyanate to form a wall polymer encapsulating the active material. Moreover, addition of gum Arabic prior to emulsification facilitates dissolution of denatured protein in the aqueous phase thereby preventing aggregation of the same. In some embodiments, the self-condensed polyisocyanate is formed in the absence of an exogenous (i.e., added) crosslinking agent such as polyamine and polyalcohol. In some embodiments, the self-condensed polyisocyanate is not crosslinked or covalently bonded with the beta-1-4 non-ionic polysaccharide.

In some embodiments, other than beta-1-4 non-ionic polysaccharide, the microcapsule shell is substantially free of or free of a biopolymer (e.g., denatured protein and gum Arabic) and/or a polyelectrolyte. In some embodiments, the microcapsule shell comprises no more than 15%, 10%, 5%, 3%, 1%, 0.5%, 0.2%, or 0.1% biopolymer other than beta-1-4 non-ionic polysaccharide, relative to the total weight of the microcapsule shell. In some embodiments, the microcapsule shell comprises no more than 15%, 10%, 5%, 3%, 1%, 0.5%, 0.2%, or 0.1% polyelectrolyte, relative to the total weight of the microcapsule shell. The term “biopolymer”, as used herein, means a polymer obtained from a natural source (e.g., plant, fungus, bacterium or animal) or modified biopolymer thereof. The biopolymer can be a polypeptide (e.g., protein) or a polysaccharide. In some embodiments, the biopolymer is selected from the group consisting of gelatin, collagen, chitosan, guar gum, gum Arabic (gum acacia), xanthan gum, proteins (e.g., pea protein), hydrophobin, enzymes, alginate, carrageenan, pectin, modified starch, and mixtures thereof.

In some embodiments, the microcapsule shell is substantially free of or free of a silicon-based material. In some embodiments, the microcapsule shell comprises no more than 2%, 1%, 0.5%, 0.2%, 0.1%, 0.05%, or 0.01% silicon-based material, relative to the total weight of the microcapsule shell. In some embodiments, the microcapsule shell is substantially free of or free of a salt (e.g., inorganic salt). In some embodiments, the microcapsule shell comprises no more than 1%, 0.5%, 0.2%, 0.1%, 0.05%, 0.01%, 0.005%, or 0.002% salt, relative to the total weight of the microcapsule shell. In some embodiments, the microcapsule shell consists essentially of or consists of the self-condensed polyisocyanate and the beta-1-4 non-ionic polysaccharide (e.g., xyloglucan), that is, the total weight of the self-condensed polyisocyanate and the beta-1-4 non-ionic polysaccharide present in the microcapsule shell is at least 90%, 95%, 98%, 99%, 99.5%, 99.8%, or 99.9%, relative to the total weight of the microcapsule shell.

The microcapsule shell of the present disclosure exhibits improved wall strength thereby providing lower microcapsule breakage percent after spraying to powders. Advantageously, the microcapsules of the present disclosure can achieve a fragrance load of up to 35% and show improved dry performance in powder detergent application as compared to similar microcapsules without beta-1-4 non-ionic polysaccharide (e.g., xyloglucan). The microcapsules can also advantageously show equal performance to commercial melamine formaldehyde capsules. Notably, denatured protein is essential in the process of producing the microcapsules in the present disclosure as replacing the denatured protein with another biopolymer dispersant such as modified starch diminished wall strength. Further, addition of the beta-1-4 non-ionic polysaccharide into the emulsion within 5 minutes after commencement of the emulsifying step (c) was found to be critical in achieving the observed improvement in wall strength and the low capsule breakage when sprayed. The microcapsules of the present disclosure find use in the encapsulation of fragrances, pro-fragrance, malodor counteractive agent, cosmetics, colorants, vitamins, antioxidants and the like and delivery of the same in consumer products such as powder detergents, liquid detergents, fabric conditioners, antiperspirants, deodorants, fine fragrances, and hair care products.

Advantageously, the microcapsule shell of the present disclosure is characterized by a rupture force of at least 100 μN. In some embodiments, the microcapsule shell is characterized by a rupture force of at least 110 μN, at least 120 μN, at least 130 μN, or at least 140 μN.

The microcapsule core comprises an active material. In some embodiments, the active material is a fragrance present at a level of from 1 wt % to 35 wt % relative to the weight of the microcapsule slurry. In some embodiments, the active material is a fragrance present in an amount of from 0.01 wt % to 1 wt %, relative to the weight of the core-shell microcapsule slurry, and the fragrance comprises at least five High Performance fragrance ingredients comprising Ultra High-Impact fragrance ingredients as listed in Table 1, High-Impact fragrance ingredients as listed in Table 2, or combinations thereof. In some embodiments, the weight ratio of the Ultra High-Impact fragrance ingredients to the High-Impact fragrance ingredients is in a range of from 1:0 to 1:19.

In some embodiments, the microcapsule core further comprises an adjunct core material such as a solvent, an emollient, and/or a core modifier material. Examples of adjunct core materials include nanoscale solid particulate materials, polymeric core modifiers, solubility modifiers, density modifiers, stabilizers, humectants, viscosity modifiers, pH modifiers, or a combination thereof. Suitable examples of adjunct core materials also include those described in WO 2016/049456 and US 2016/0158121. In some embodiments, the solvent comprises caprylic/capric triglyceride. In some embodiments, the solvent comprises benzyl benzoate. In some embodiments, the adjunct core material can also be present in the wall or outside the capsule in the slurry. In some embodiments, the adjunct core material can be present in the core in an amount of from 0.01% to 25% (e.g., from 0.5% to 10%) by weight of the capsule.

In some embodiments, the core-shell microcapsules have diameter ranging from 0.1 micron to 1000 microns (e.g., from 0.5 micron to 500 microns, from 1 micron to 200 microns, from 1 micron to 100 microns, or from 1 micron to 50 micron). In some embodiments, the core-shell microcapsules have diameter of at least 0.1 micron, 0.5 micron, 1 micron, 2 microns, 5 microns or 20 microns. In some embodiments, the core-shell microcapsules have diameter of no more than 1000 microns, 500 microns, 200 microns, 100 microns, 75 microns, 50 microns, 30 microns, 20 microns, 10 microns or 5 microns. The microcapsules in the present disclosure don't have to be perfectly spherical. The term “diameter”, as used herein with respect to a microcapsule, means the diameter of a sphere having the same volume as the microcapsule.

In some embodiments, the hydrocolloid comprises gum Arabic added to an aqueous phase before an emulsification step during formation of the slurry. In some embodiments, the microcapsule slurry is an aqueous suspension of the microcapsule. In some embodiments, the microcapsule slurry is white. In some embodiments, the core-shell microcapsule slurry comprises a microcapsule formation aid. The microcapsule slurry may be used directly in a consumer product. The microcapsule slurry may also be washed, coated, dried (e.g., spray-dried) and/or combined with one or more other microcapsules, active materials, and/or carrier materials.

In some embodiments, the microcapsule shell is biodegradable. The term “biodegradable” as used herein with respect to a material, such as a microcapsule shell as a whole or a polymer of the microcapsule shell, means that the material has no real or perceived health and/or environmental issues, and is capable of undergoing and/or does undergo physical, chemical, thermal, microbial, biological and/or UV or photo-degradation. Ideally, a microcapsule shell and/or polymer is deemed “biodegradable” when the microcapsule shell and/or polymer passes one or more of the following tests including: a respirometry biodegradation method in aquatic media, available from Organization for Economic Cooperation and Development (OECD), International Organization for Standardization (ISO) and the American Society for Testing and Material (ASTM) tests including, but not limited to OECD 301F or 310 (Ready biodegradation), OECD 302 (inherent biodegradation), ISO 17556 (solid stimulation studies), ISO 14851 (fresh water stimulation studies), ISO 18830 (marine sediment stimulation studies), OECD 307 (soil stimulation studies), OECD 308 (sediment stimulation studies), and OECD 309 (water stimulation studies). Preferably, the microcapsules are readily biodegradable as determined using a respirometry biodegradation method in aquatic media, the OECD 301F or OECD 310 test. More preferably, the microcapsule shell and/or polymer is biodegradable if the shell and/or polymer has a biodegradation rate of at least 20%, 30%, 40%, 50%, 60%, 65%, 70%, 75%, 80%, 85%, 90%, 95% or 98%, based on the weight of the shell and/or polymer, within 60 days according to the OECD301F or OECD310 tests, or most preferably a biodegradability of at least 20% within 60 days according to OECD301F test.

In some embodiments, the shell of the microcapsule has a biodegradation rate of at least 20%, 30%, 40%, 50%, 60%, 65%, 70%, 75%, 80%, 85%, 90%, 95% or 98%, based on the weight of the shell, within 60 days according to OECD301F or OECD310. In some embodiments, the shell of the microcapsule has a biodegradation rate of at least 20%, based on the weight of the shell, within 60 days according to OECD301F or OECD310.

The present disclosure also provides a process for producing a core-shell microcapsule slurry. The present disclosure also provides a core-shell microcapsule slurry obtainable by the processes described in this disclosure. The process comprises: (a) providing an aqueous phase comprising a denatured protein and gum Arabic, wherein the denatured protein comprises a denatured pea protein and/or a denatured whey protein; (b) providing an oil phase comprising an active material and a polyisocyanate; (c) emulsifying the oil phase with the aqueous phase to form an emulsion; (d) adding all of a beta-1-4 non-ionic polysaccharide to the emulsion within 5 minutes after commencement of the emulsifying step (c) to form a microcapsule slurry comprising core-shell microcapsules; and (e) curing the shell of the microcapsules at a temperature in the range of from 40° C. to 90° C.

In step (a), an aqueous phase is prepared and provided. In some embodiments, the aqueous phase is homogenous. In some embodiments, the aqueous phase has a pH below 6 or 5.5. In some embodiments, the aqueous phase has a pH in a range of from 2 to 6, or from 3 to 5.5, or from 3.5 to 4.5, or from 3.8 to 4.2. The aqueous phase comprises a denatured protein and gum Arabic. Addition of gum Arabic prior to emulsification facilitates dissolution of denatured protein in the aqueous phase thereby preventing aggregation of the same. In some embodiments, the denatured protein comprises or is a denatured pea protein. In some embodiments, the denatured protein comprises or is a denatured whey protein. In some embodiments, the aqueous phase further comprises xanthan gum. In some embodiments, the aqueous phase further comprises tannic acid.

In some embodiments, step (a) further comprises denaturing a protein (pea protein and/or whey protein) in an aqueous solution. In some embodiments, a pea protein is denatured by heating an aqueous pea protein solution to a temperature of from 80° C. to 170° C., or from 80° C. to 140° C., or from 80° C. to 120° C., or from 80° C. to 105° C., or from 80° C. to 90° C. In some embodiments, the pea protein and/or the whey protein is denatured by a denaturing agent. In some embodiments, the pea protein and/or the whey protein is denatured by a chaotropic agent. In some embodiments, the chaotropic agent comprises or is a guanidinium salt. In some embodiments, the guanidinium salt is selected from the group consisting of guanidinium sulphate, guanidinium carbonate, guanidinium nitrate, guanidinium chloride, and mixtures thereof. In some embodiments, the chaotropic agent comprises or is guanidine carbonate. In some embodiments, the denaturing step comprises mixing guanidine carbonate with a pea protein and/or a whey protein in an aqueous solution (e.g., aqueous phase). In some embodiments, the denaturing step comprises: (i) mixing a pea protein with water to form an aqueous mixture, (ii) adjusting the pH of the aqueous mixture to above 9, (iii) adding gum arabic to the aqueous mixture, and (iv) adding guanidine carbonate to the aqueous mixture and adjusting the pH to below 6. In some embodiments, xanthan gum and/or tannic acid is added into the aqueous phase during or after the denaturing step.

In step (b), an oil phase is prepared and provided. The oil phase comprises an active material and a polyisocyanate. In some embodiments, the polyisocyanate comprises or is an aromatic polyisocyanate. In some embodiments, the polyisocyanate comprises or is trimethylol propane-adduct of xylylene diisocyanate. In some embodiments, the amount of the polyisocyanate present in the oil phase is in a range of from 0.1% to 10%, from 0.1% to 8%, from 0.2% to 5%, from 1.5% to 3.5%, from 0.1% to 5%, from 0.1% to 4%, or from 0.1% to 2%, based on the weight of the microcapsule slurry. In some embodiments, the amount of the polyisocyanate present in the oil phase is less than 1%, less than 0.95%, less than 0.9%, less than 0.85%, less than 0.8%, less than 0.7%, less than 0.6%, less than 0.5%, less than 0.4%, less than 0.3%, less than 0.2%, or less than 0.1%, based on the weight of the microcapsule slurry. In some embodiments, the oil phase further comprises an adjunct core material such as a solvent, an emollient, and/or a core modifier material. In some embodiments, the solvent is selected from the group consisting of caprylic/capric triglyceride, benzyl benzoate, 3-methoxybutyl acetate, phenyl ethyl benzoate, and mixtures thereof. The oil phase can be prepared by mixing an active material and a polyisocyanate. In some embodiments, an adjunct core material (e.g., a solvent) is also mixed with the active material and the polyisocyanate. In some embodiments, the polyisocyanate is dissolved in a solution comprising a solvent (e.g., caprylic/capric triglyceride) and an active material.

In step (c), the oil phase is emulsified with the aqueous phase to form an emulsion. In some embodiments, an emulsifier is used in step (c), that is, the emulsion comprises an emulsifier (e.g., a sulfonated polystyrene). The emulsifying process can be carried out using technologies known in the art. For example, a stirrer, an agitator or a homogenizer (e.g., high shear homogenizer) can be used for emulsification.

In step (d), all of a beta-1-4 non-ionic polysaccharide is added into the emulsion within 5 minutes after the emulsification begins (i.e., after commencement of the emulsifying step (c)) to form a microcapsule slurry comprising core-shell microcapsules. In some embodiments, the beta-1-4 non-ionic polysaccharide comprises or is xyloglucan. In some embodiments, all of a beta-1-4 non-ionic polysaccharide is added into the emulsion within 14 minutes, or within 13 minutes, or within 12 minutes, or within 11 minutes, or within 10 minutes, or within 9 minutes, or within 8 minutes, or within 7 minutes, or within 6 minutes, or within 5 minutes, or within 4.5 minutes, or within 4 minutes, or within 3.5 minutes, or within 3 minutes, or within 2.5 minutes, or within 2 minutes, or within 1.5 minutes, or within 1 minute after the emulsification begins. In some embodiments, the amount of beta-1-4 non-ionic polysaccharide (e.g., xyloglucan) added to the emulsion in step (d) is in a range of from about 0.1 wt % to about 5 wt %, or from about 0.1 wt % to about 2 wt %, or from about 0.1 wt % to about 1 wt %, or from about 0.1 wt % to about 0.5 wt %, based on the weight of the microcapsule slurry. In some embodiments, the amount of beta-1-4 non-ionic polysaccharide (e.g., xyloglucan) added to the emulsion in step (d) is at least about 0.05 wt %, or at least about 0.1 wt %, or at least about 0.15 wt %, or at least about 0.2 wt %, based on the weight of the microcapsule slurry. In some embodiments, the amount of beta-1-4 non-ionic polysaccharide (e.g., xyloglucan) added to the emulsion in step (d) is no more than about 5 wt %, or no more than about 4 wt %, or no more than about 3 wt %, or no more than about 2 wt %, or no more than about 1 wt %, or no more than about 0.5 wt %, based on the weight of the microcapsule slurry.

In step (e), the microcapsule shell is cured at a temperature in the range of from 40° C. to 90° C. In some embodiments, the curing step (e) is performed after step (d) (addition of beta-1-4 non-ionic polysaccharide (e.g., xyloglucan) into the emulsion). The term “curing”, as used herein, means a toughening or hardening process of a polymer brought about by heat, chemical additives, and/or light radiation. In some embodiments, the microcapsule shell is cured at a temperature in the range of from 50° C. to 80° C., or from 55° C. to 80° C., or from 55° C. to 75° C., or from 55° C. to 70° C., or from 60° C. to 70° C., or from 60° C. to 68° C., or from 63° C. to 67° C. In some embodiments, the microcapsule shell is cured at a temperature below 90° C., 80° C., or 70° C. In some embodiments, the microcapsule shell is cured for about 30 minutes to 24 hours, or 1 hour to 8 hours, or 2 hours to 6 hours, or 1 minute to 10 hours, or 0.1 hours to 5 hours, or 0.2 hours to 4 hours, or 0.5 hours to 3 hours.

In some embodiments, the process may further comprise a step of drying the core-shell microcapsules to remove water. The microcapsules can be dried at a temperature of from 20° C. to 250° C., or at room temperature. In some embodiments, the microcapsules are dried by a dehumidifier configured to supply desiccated air to the microcapsules, a radiant heat source for facilitating drying of the microcapsules, or submitting the microcapsules under a gas flow to obtain dried free-flowing microcapsules. It is understood that any standard method known by a person skilled in the art to perform such drying is also applicable.

Advantageously, the inclusion of a denatured protein and beta-1-4 non-ionic polysaccharide (e.g., xyloglucan) in the process of producing microcapsule provides desirable microcapsule properties such as reduced microcapsule breakage percent after spraying to powders and improved dry performance in a powder detergent application.

One or more rheology modifiers or viscosity control agents can be added to the microcapsule slurry to achieve a desired viscosity of the slurry so that the microcapsule is dispersed in the slurry for a prolonged period of time. During capsule preparation, the rheology modifier is preferably added prior to the emulsification of the aqueous phase and oil phase and is typically dispersed homogeneously in the microcapsule slurry and outside of the microcapsule wall. Suitable rheology modifiers include an acrylate copolymer, a cationic acrylamide copolymer, a polysaccharide, or a combination thereof. In certain aspects, polysaccharides of use as rheology modifiers include starches, pectin, and vegetable gums such as alginate, guar gum, locust bean gum, and xanthan gum. Preferably, the at least one rheology modifier is a xanthan gum.

One or more preservatives can be added to the microcapsule slurry to prevent damage or inadvertent growth of microorganisms for a specific period of time thereby increasing shelf life. The preservative can be any organic preservative that does not cause damage to the microcapsule slurry. Suitable water-soluble preservatives include organic sulfur compounds, halogenated compounds, cyclic organic nitrogen compounds, low molecular weight aldehydes, parabens, propanediol materials, isothiazolinone, quaternary compounds, benzoates, and combinations thereof. Exemplary preservatives include low molecular weight alcohols, dehydroacetic acids, phenyl and phenoxy compounds, and combinations thereof. A non-limiting example of commercially available water-soluble preservative is a mixture of about 77% 5-chloro-2-methyl-4-isothiazolin-3-one and 23% 2-methyl-4-isothiazolin-3-one. Additional antibacterial preservatives include a combination of methylchloroisothiazolinone and methylisothiazolinone available under the tradename KATHON® CG; 5-bromo-5-nitro-1,3-dioxane available under the tradename BRONIDOX L®; 2-bromo-2-nitro-1,3-propanediol available under the tradename BRONOPOL®; 1,1′-Hexamethylenebis (5-(p-chlorophenyl) biguanide) and salts thereof, such as acetates and digluconates; 1,3-bis (hydroxy) available under the tradename GLYDANT PLUS®; glutaraldehyde; ICI Polyaminopropylbiguanide; dehydroacetic acid; and 1,2-benzisothiazolin-3-one sold under the tradename PROXEL® GXL.

The microcapsule slurry can be formulated into a capsule delivery system for use in consumer products. The capsule delivery system can be a microcapsule slurry suspended in an external solvent (e.g., water, ethanol, or a combination thereof), wherein the capsule is present at a level from about 0.1% to about 80% (e.g., 70-75%, 40-55%, 50-90%, 1% to 65%, or 5% to 45%) by weight of the capsule delivery system.

In some embodiments, the microcapsule and its slurry prepared in accordance with the present disclosure is subsequently purified. In some embodiments, purification can be achieved by washing the microcapsule slurry with water until a neutral pH is obtained.

### Applications

The microcapsule and the microcapsule slurry of the present disclosure are well-suited for use in a fabric softener, a fabric refresher, or a laundry detergent. Liquid or powder laundry detergents which can use the microcapsule and the microcapsule slurry of the present disclosure include those systems described in U.S. Pat. Nos. 5,929,022, 5,916,862, 5,731,278, 5,565,145, 5,470,507, 5,466,802, 5,460,752, 5,458,810, 5,458,809, 5,288,431, 5,194,639, 4,968,451, 4,597,898, 4,561,998, 4,550,862, 4,537,707, 4,537,706, 4,515,705, 4,446,042, and 4,318,818. Unit dose pouches, tablets and capsules include those described in EP 1431382 A1, US 2013/0219996 A1, US 2013/0284637 A1, and U.S. Pat. No. 6,492,315. These unit dose formulations can contain high concentrations of a functional material (e.g., about 5-100% fabric softening agent or detergent active), fragrance (e.g., 0.5-100%, 0.5-40%, and 0.5-15%), and flavor (e.g., 0.1-100%, 0.1-40%, and 1-20%). In addition, they can contain no water to limit the water content as low as less than 30% (e.g., less than 20%, less than 10%, and less than 5%). Fabric care products such as rinse conditioners (containing 1 to 30 weight % of a fabric conditioning active), fabric liquid conditioners (containing 1 to 30 weight % of a fabric conditioning active), fabric refreshers, fabric refresher sprays, ironing liquids, and fabric softener systems such as those described in U.S. Pat. Nos. 6,335,315, 5,674,832, 5,759,990, 5,877,145, 5,574,179, 5,562,849, 5,545,350, 5,545,340, 5,411,671, 5,403,499, 5,288,417, 4,767,547 and 4,424,134.

Liquid fabric softeners/fresheners contain at least one fabric softening agent present preferably at a concentration of 1 to 30% (e.g., 4% to 20%, 4% to 10%, and 8% to 15%). The ratio between the active material and the fabric softening agent can be 1:500 to 1:2 (e.g., 1:250 to 1:4 and 1:100 to 1:8). As an illustration, when the fabric softening agent is 5% by weight of the fabric softener, the active material is 0.01% to 2.5%, preferably 0.02% to 1.25% and more preferably 0.1% to 0.63%. As another example, when the fabric softening agent is 20% by weight of the fabric softener, the active material is 0.04% to 10%, preferably 0.08% to 5% and more preferably 0.4% to 2.5%. The active material is a fragrance, malodor counteractant or a combination thereof. The liquid fabric softener can have 0.15% to 15% of capsules (e.g., 0.5% to 10%, 0.7% to 5%, and 1% to 3%). When including capsules at these levels, the neat oil equivalent (NOE) in the softener is 0.05% to 5% (e.g., 0.15% to 3.2%, 0.25% to 2%, and 0.3% to 1%).

Suitable fabric softening agents include cationic surfactants. Non-limiting examples are quaternary ammonium compounds such as alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, or a combination thereof. Fabric softening compositions, and components thereof, are generally described in US 2004/0204337 and US 2003/0060390. Suitable softening agents include esterquats sold under the tradename REWOQUAT® WE 18 commercially available from Evonik Industries and STEPANTEX® SP-90 commercially available from Stepan Corporation.

In particular aspects, the microcapsule slurry is used in a consumer product such as a fabric softener, a fabric refresher, or a laundry detergent, preferably the consumer product is in the form of a spray-dried powder. Accordingly, the present disclosure also provides a consumer product (e.g., a fabric softener, a fabric refresher, or a laundry detergent) comprising the core-shell microcapsule slurry of this disclosure. In certain aspects, the consumer product further comprises one or more detersive enzymes. Ideally, the microcapsule slurry is present at a level between 0.1 wt % and 10 wt %, relative to the weight of the consumer product.

Having demonstrated that the inclusion of a beta-1-4 non-ionic polysaccharide improves the performance of the microcapsules, the present disclosure further provides a method for improving the performance of a core-shell microcapsule in a powder application by preparing a core-shell microcapsule in the presence of a denatured pea protein and/or a denatured whey protein and with addition of a beta-1-4 non-ionic polysaccharide, such as xyloglucan, into the emulsion within 5 minutes after commencement of the emulsification. In particular, inclusion of a beta-1-4 non-ionic polysaccharide in the preparation of the microcapsule was found to provide a higher rupture force, improve applied stress tolerance, improve sensory performance, enhance deposition of the microcapsule on a surface, and/or increase stability of the microcapsule slurry.

Many aspects and embodiments have been described above and are merely exemplary and not limiting. After reading this specification, skilled artisans appreciate that other aspects and embodiments are possible without departing from the scope of the invention.

### EXAMPLES

The following non-limiting examples are provided to further illustrate the present invention and are not to be construed as limitations of the invention, as many variations of the present invention are possible without departing from its spirit or scope.

### Method for Measuring the Rupture Force

The rupture force of microcapsules was measured using a micromanipulation technique based on the parallel plate compression of individual microcapsules. Two droplets (~75 μL/droplet) of microcapsule slurry slightly diluted with water were pipetted onto a highly tempered glass slide with a smooth polished flat surface (19.76 cm²; length 7.6 cm; width 2.6 cm; thickness 0.3 cm) using a pipette, which were left air-drying for 2 hours. The glass slide was secured onto a metal stage and placed beneath a borosilicate glass probe with a tip of 60 m. The tip was longitudinally superglued (Loctite Cyanoacrylate Superglue, Henkel, Germany, EU) onto the output borosilicate glass tube of a selected force transducer head (Series 403A, Model 1568, maximum force scale 5.0 mN, Sensitivity 0.459 mN·V⁻¹; Aurora Scientific Inc., Ontario, Canada) paired with an electrically powered control box (Signal Interface 604A, Aurora Scientific Inc., Ontario, Canada). The force transducer was mounted onto a three-dimensional fine platform (300-P, Newport Corporation, Irvine, CA, USA) controlled by a servo motor (821A-MC1000e, Siskiyou Corporation, Grants Pass, OR, USA). The high resolution (±0.2 μm) micromanipulator was operated to move the glass probe upwards/downwards. A descending speed (e.g., 1.33 μm·s⁻¹) was selected, which allowed the probe tip to contact and progressively compress each single microcapsule. Microcapsules were digitally observed through a camera (high sensitivity color, 1280×1024 pixel C-Mount Camera, DCC1240C, Thorlabs, Newton, NJ, USA) with the help of a High-Intensity Fiber-Coupled Illuminator (OSL2, Thorlabs, Newton, NJ, USA). Ten single randomly selected microcapsules were squashed to generate statistically significant results. The measurement of the rupture force in this disclosure is based on a technique known in the art as micromanipulation. See, e.g., Baiocco et al., Microplastic-Free Microcapsules to Encapsulate Health-Promoting Limonene Oil, Molecules 2022, 27, 7215, the disclosure of which is incorporated herein by reference in its entirety for all purposes.

### Example 1: Microcapsule Prepared in the Presence of Denatured Pea Protein and with Xyloglucan (XG) Added to the Emulsion within 1 Minute after Emulsification Begins

An oil phase was prepared by mixing a fragrance, caprylic/capric triglyceride (NEOBEE® M-5) and trimethylol propane-adduct of xylylene diisocyanate (TAKENATE® D-110N). Separately, an aqueous phase was prepared by dispersing pea protein powder in water and adjusting the pH to 9.5 with NaOH (37 wt % aqueous solution). Then gum arabic was added to the aqueous phase together with high molecular weight polystyrene sulfonate, sodium salt (FLEXAN® II), and the resulting mixture was mixed to homogeneity. Guanidine carbonate (denaturing agent) and citric acid solutions were mixed and added to the aqueous phase. Reaction was carried out under an acidic condition for 15 minutes to denature the pea protein. Xanthan gum (1% solution) was added to the aqueous phase together with tannic acid (Tanal-02, 30% solution). The oil phase was then added to the aqueous phase, and emulsification was performed by an IKA ULTRA-TURRAX® homogenizer at 6000 rpm (revolutions per minute) to form an oil-in-water emulsion. All xyloglucan (2% solution) were added to the emulsion within 1 minute after the emulsification began. Curing of the microcapsule shell was carried out at 65° C. for 3 hours and 15 minutes. The microcapsule slurry was cooled to room temperature and a preservative (1,2-benzisothiazolin-3-one sold under the tradename PROXEL® GXL) was added to form the final microcapsule slurry (Microcapsule 1). Ingredients and their amounts used in the preparation of the slurry are shown in Table 3. Microcapsule 1 contained a fragrance load of 27.1%.

TABLE 3
Microcapsule 1

| | Amount (g) | Weight % |
|---|---|---|
| Fragrance | 187.2 | 27.1 |
| Caprylic/capric triglyceride | 46.8 | 6.8 |
| Pea protein | 12.5 | 1.8 |
| Guanidine Carbonate | 7.6 | 1.1 |
| Citric acid | 15.5 | 2.2 |
| FLEXAN ® II | 1.5 | 0.2 |
| Gum Arabic | 8.5 | 1.2 |
| TAKENATE ® D-110N | 5.9 | 0.9 |
| Tanal-02 | 3.0 | 0.4 |
| Xanthan gum | 0.5 | 0.07 |
| Xyloglucan | 1.8 | 0.3 |
| PROXEL ® GXL | 0.6 | 0.1 |
| Water | 399 | 57.8 |
| Total | 690 | 100 |

### Example 2 (Comparative): Microcapsule Prepared in the Presence of Denatured Pea Protein and with XG Added to the Aqueous Phase at about 15 Minutes Before Emulsification Begins

Microcapsule 2 (microcapsule slurry) was prepared as described in Example 1 except that all xyloglucan (XG) were added to the aqueous phase (before the oil phase and the aqueous phase were mixed) at about 15 minutes before the emulsification began.

### Example 3 (Comparative): Microcapsule Prepared in the Presence of Denatured

Pea Protein and with XG Added to the Emulsion at about 15 Minutes after Emulsification Begins

Microcapsule 3 (microcapsule slurry) was prepared as described in Example 1 except that all xyloglucan (XG) were added to the emulsion at about 15 minutes after the emulsification began.

### Example 4 (Comparative): Microcapsule Prepared in the Presence of Denatured

Pea Protein and with XG Added to the Emulsion at about 45 Minutes after Emulsification Begins

Microcapsule 4 (microcapsule slurry) was prepared as described in Example 1 except that all xyloglucan (XG) were added to the emulsion at about 45 minutes after the emulsification began.

### Example 5: Microcapsule Prepared with Additional Amount of Tannic Acid

Microcapsule 5 (microcapsule slurry) was prepared as described in Example 1 except that the amount of tannic acid was doubled. Ingredients and their amounts used in the preparation of the slurry are shown in Table 4. Microcapsule 5 contained a fragrance load of 26.7%.

TABLE 4
Microcapsule 5

| | Amount (g) | Weight % |
|---|---|---|
| Fragrance | 187.2 | 26.7 |
| Caprylic/capric triglyceride | 46.8 | 6.7 |
| Pea protein | 12.5 | 1.8 |
| Guanidine Carbonate | 7.6 | 1.1 |
| Citric acid | 15.5 | 2.2 |
| FLEXAN ® II | 1.5 | 0.2 |
| Gum Arabic | 8.5 | 1.2 |
| TAKENATE ® D-110N | 5.9 | 0.8 |
| Tanal-02 | 6.0 | 0.9 |
| Xanthan gum | 0.5 | 0.1 |
| Xyloglucan | 1.8 | 0.3 |
| PROXEL ® GXL | 0.6 | 0.1 |
| Water | 411 | 58 |
| Total | 700 | 100 |

### Example 6 (Comparative): Microcapsule Prepared without Xyloglucan (XG)

Microcapsule 6 (microcapsule slurry) was prepared as described in Example 5 except that no xyloglucan was used in the preparation of the microcapsule slurry. Ingredients and their amounts used in the preparation of the slurry are shown in Table 5. Microcapsule 6 contained a fragrance load of 30.7%.

TABLE 5
Microcapsule 6

| | Amount (g) | Weight % |
|---|---|---|
| Fragrance | 187.2 | 30.7 |
| Caprylic/capric triglyceride | 46.8 | 7.7 |
| Pea protein | 12.5 | 2.0 |
| Guanidine Carbonate | 7.6 | 1.2 |
| Citric acid | 15.5 | 2.5 |
| FLEXAN ® II | 1.5 | 0.2 |
| Gum Arabic | 8.5 | 1.4 |
| TAKENATE ® D-110N | 5.9 | 1.0 |
| Tanal-02 | 6.0 | 1.0 |
| Xanthan gum | 0.5 | 0.1 |
| PROXEL ® GXL | 0.6 | 0.1 |
| Water | 317 | 52 |
| Total | 610 | 100 |

### Example 7: Microcapsule Prepared with Reduced Amount of XG

Microcapsule 7 (microcapsule slurry) was prepared as described in Example 1 except that the amount of xyloglucan (XG) was reduced by 50%. Ingredients and their amounts used in the preparation of the slurry are shown in Table 6. Microcapsule 7 contained a fragrance load of 29.0%.

TABLE 6
Microcapsule 7

| | Amount (g) | Weight % |
|---|---|---|
| Fragrance | 187.2 | 29.0 |
| Caprylic/capric triglyceride | 46.8 | 7.3 |
| Pea protein | 12.5 | 1.9 |
| Guanidine Carbonate | 7.6 | 1.2 |
| Citric acid | 15.5 | 2.4 |
| FLEXAN ® II | 1.5 | 0.2 |
| Gum Arabic | 8.5 | 1.3 |
| TAKENATE ® D-110N | 5.9 | 0.9 |
| Tanal-02 | 3.0 | 0.5 |
| Xanthan gum | 0.5 | 0.1 |
| Xyloglucan | 0.9 | 0.1 |
| PROXEL ® GXL | 0.6 | 0.1 |
| Water | 346 | 53.6 |
| Total | 645 | 100 |

### Example 8: Microcapsule Prepared with Reduced Fragrance Load

Microcapsule 8 (microcapsule slurry) was prepared as described in Example 1 except that the amount of fragrance was reduced. Ingredients and their amounts used in the preparation of the slurry are shown in Table 7. Microcapsule 8 contained a fragrance load of 21.7%.

TABLE 7
Microcapsule 8

| | Amount (g) | Weight % |
|---|---|---|
| Fragrance | 150 | 21.7 |
| Caprylic/capric triglyceride | 37.5 | 5.4 |
| Pea protein | 12.5 | 1.8 |
| Guanidine Carbonate | 7.6 | 1.1 |
| Citric acid | 15.5 | 2.2 |
| FLEXAN ® II | 1.5 | 0.2 |
| Gum Arabic | 8.5 | 1.2 |
| TAKENATE ® D-110N | 5.9 | 0.9 |
| Tanal-02 | 3.0 | 0.4 |
| Xanthan gum | 0.5 | 0.1 |
| Xyloglucan | 1.8 | 0.3 |
| PROXEL ® GXL | 0.6 | 0.1 |
| Water | 445 | 65 |
| Total | 690 | 100 |

### Example 9: Microcapsule Prepared with Additional Amount of Trimethylol Propane-Adduct of Xylylene Diisocyanate

Microcapsule 9 (microcapsule slurry) was prepared as described in Example 1 except that additional amount of trimethylol propane-adduct of xylylene diisocyanate (TAKENATE® D-110N) was used. Ingredients and their amounts used in the preparation of the slurry are shown in Table 8. Microcapsule 9 contained a fragrance load of 26.9%.

TABLE 8
Microcapsule 9

| | Amount (g) | Weight % |
|---|---|---|
| Fragrance | 187.2 | 26.9 |
| Caprylic/capric triglyceride | 46.8 | 6.7 |
| Pea protein | 12.5 | 1.8 |
| Guanidine Carbonate | 7.6 | 1.1 |
| Citric acid | 15.5 | 2.2 |
| FLEXAN ® II | 1.5 | 0.2 |
| Gum Arabic | 8.5 | 1.2 |
| TAKENATE ® D-110N | 8.8 | 1.3 |
| Tanal-02 | 3.0 | 0.4 |
| Xanthan gum | 0.5 | 0.1 |
| Xyloglucan | 1.8 | 0.3 |
| PROXEL ® GXL | 0.6 | 0.1 |
| Water | 399 | 58 |
| Total | 690 | 100 |

### Example 10 (Comparative): Microcapsule Prepared in the Presence of Modified Starch

An oil phase was prepared by mixing a fragrance, caprylic/capric triglyceride (NEOBEE® M-5) and a mixture of two polyisocyanates (trimethylol propane-adduct of xylylene diisocyanate (TAKENATE® D-110N) and biuret of hexamethylene diisocyanate (DESMODUR® N100A)). Separately, an aqueous phase was prepared by dispersing a modified starch powder sold under the tradename PURITY GUM® Ultra (Ingredion, Westchester, IL) in water. Then high molecular weight polystyrene sulfonate, sodium salt (FLEXAN® II, 10% solution) was added to the aqueous phase together with carboxymethyl cellulose (1% solution) and 1,4-diazabicyclo[2.2.2]octane (DABCO, 20% solution), and the resulting mixture was mixed to homogeneity. Tannic acid (Tanal-01, 30% solution) was added to the aqueous phase. The oil phase was then added to the aqueous phase, and emulsification was performed by an IKA ULTRA-TURRAX® homogenizer at 6000 rpm (revolutions per minute) to form an oil-in-water emulsion. Curing of the microcapsule shell was carried out at 80° C. for 4 hours and 15 minutes. After 1 hour of curing, xyloglucan (2% solution) was added to the microcapsule slurry, followed by addition of second dose of biuret of hexamethylene diisocyanate (DESMODUR® N100A). The microcapsule slurry was cooled to room temperature and a preservative (1,2-benzisothiazolin-3-one sold under the tradename PROXEL® GXL) was added to form the final microcapsule slurry (Microcapsule 10). Ingredients and their amounts used in the preparation of the slurry are shown in Table 9. Microcapsule 10 contained a fragrance load of 30.0%.

TABLE 9
Microcapsule 10

| | Amount (g) | Weight % |
|---|---|---|
| Fragrance | 180 | 30 |
| Caprylic/capric triglyceride | 45 | 7.5 |
| PURITY GUM ® Ultra | 21 | 3.5 |
| FLEXAN ® II | 3.02 | 0.50 |
| Carboxymethyl cellulose | 0.15 | 0.03 |
| DABCO | 0.13 | 0.02 |
| TAKENATE ® D-110N | 2.4 | 0.4 |
| DESMODUR ® N100A | 4.8 | 0.8 |
| Tanal-01 | 3.0 | 0.50 |
| Xyloglucan | 1.8 | 0.3 |
| PROXEL ® GXL | 0.65 | 0.11 |
| Water | 368.65 | 61.4 |
| Total | 600 | 100 |

### Example 11 (Comparative): Microcapsule Prepared in the Presence of Modified Starch

Microcapsule 11 (microcapsule slurry) was prepared as described in Example 10 except that the amount of biuret of hexamethylene diisocyanate (DESMODUR® N100A) was reduced and the amount of tannic acid (Tanal-01) was increased. Ingredients and their amounts used in the preparation of the slurry are shown in Table 10. Microcapsule 11 contained a fragrance load of 30.0%.

TABLE 10
Microcapsule 11

| | Amount (g) | Weight % |
|---|---|---|
| Fragrance | 180 | 30 |
| Caprylic/capric triglyceride | 45 | 7.5 |
| Purity Gum Ultra | 21 | 3.5 |
| FLEXAN ® II | 3.02 | 0.50 |
| Carboxymethyl cellulose | 0.15 | 0.03 |
| DABCO | 0.13 | 0.02 |
| TAKENATE ® D-110N | 2.4 | 0.4 |
| DESMODUR ® N100A | 2.4 | 0.4 |
| Tanal-01 | 6.0 | 1.0 |
| Xyloglucan | 1.8 | 0.3 |
| PROXEL ® GXL | 0.65 | 0.11 |
| Water | 382.45 | 63.7 |
| Total | 600 | 100 |

### Example 12 (Comparative): Microcapsule Prepared in the Presence of Modified Starch

Microcapsule 12 (microcapsule slurry) was prepared as described in Example 11 except that the amount of xyloglucan was reduced. Ingredients and their amounts used in the preparation of the slurry are shown in Table 11. Microcapsule 12 contained a fragrance load of 30.0%.

TABLE 11
Microcapsule 12

| | Amount (g) | Weight % |
|---|---|---|
| Fragrance | 180 | 30 |
| Caprylic/capric triglyceride | 45 | 7.5 |
| Purity Gum Ultra | 21 | 3.5 |
| FLEXAN ® II | 3.02 | 0.50 |
| Carboxymethyl cellulose | 0.15 | 0.03 |
| DABCO | 0.13 | 0.02 |
| TAKENATE ® D-110N | 2.4 | 0.4 |
| DESMODUR ® N100A | 2.4 | 0.4 |
| Tanal-01 | 6.0 | 1.0 |
| Xyloglucan | 0.9 | 0.15 |
| PROXEL ® GXL | 0.65 | 0.11 |
| Water | 383.25 | 63.85 |
| Total | 600 | 100 |

### Example 13 (Comparative): Melamine Formaldehyde Microcapsule Prepared with Xyloglucan Deposition Aid

An oil phase was prepared by mixing a fragrance and caprylic/capric triglyceride (NEOBEE® M-5). Separately, an aqueous phase was prepared by dispersing a copolymer of acrylamide and acrylic acid (sold under the tradename ALCAPSOL® 200) and a methylated melamine formaldehyde resin (sold under the tradename CYMEL® 385) in water. These two components were allowed to react under acidic conditions for at least one hour. The oil phase was then added to the aqueous phase, and emulsification was performed by an IKA ULTRA-TURRAX® homogenizer to form an oil-in-water emulsion. Xyloglucan (1% solution) was added into the emulsion as a deposition aid. Curing of the microcapsule shell was carried out at 125° C. The microcapsule slurry was then cooled to room temperature and ethylene urea was added into the microcapsule slurry. Additionally, a rheology modifier (ACULYN® 33) and a preservative were added into the microcapsule slurry and the pH was adjusted using NaOH to form the final microcapsule slurry (Microcapsule 13). Ingredients and their amounts used in the preparation of the slurry are shown in Table 12. Microcapsule 13 contained a fragrance load of 24.37%.

TABLE 12
Comparative Microcapsule 13

| | Amount (g) | Weight % |
|---|---|---|
| Microcapsule Core | | |
| Fragrance | 182 | 28 |
| Caprylic/capric triglyceride | 45.5 | 7 |
| Microcapsule Wall | | |
| Copolymer of acrylamide and acrylic acid | 74 | 11.4 |
| Methylated melamine formaldehyde resin | 10 | 1.5 |
| Xyloglucan | 1.685 | 0.26 |
| Ethylene Urea | 13.3 | 2 |
| ACULYN ® 33 | 6.5 | 1 |
| Water | 319.2 | 48.84 |
| Total | 650 | 100 |

### Example 14 (Comparative): Microcapsule Prepared without Xyloglucan (XG)

Microcapsule 14 (microcapsule slurry) was prepared as described in Example 1 except that no xyloglucan was used in the preparation of the microcapsule slurry. Ingredients and their amounts used in the preparation of the slurry are shown in Table 13. Microcapsule 14 contained a fragrance load of 31.2%.

TABLE 13
Comparative Microcapsule 14

| | Amount (g) | Weight % |
|---|---|---|
| Fragrance | 187.2 | 31.2 |
| Caprylic/capric triglyceride | 46.8 | 7.8 |
| Pea protein | 12.5 | 2.1 |
| Guanidine Carbonate | 7.6 | 1.3 |
| Citric acid | 15.5 | 2.6 |
| FLEXAN ® II | 1.5 | 0.3 |
| Gum Arabic | 8.5 | 1.4 |
| TAKENATE ® D-110N | 5.9 | 1.0 |
| Tanal-02 | 3.0 | 0.5 |
| Xanthan gum | 0.5 | 0.1 |
| PROXEL ® GXL | 0.6 | 0.1 |
| Water | 311 | 51.7 |
| Total | 600 | 100.0 |

### Example 15: Preparation of Powder Detergent Samples Containing Microcapsules

Un-fragranced bio-detergent powder was used. Respectively, Microcapsules 1-14 were diluted with water and added to the powder detergent and mixed. The fragrance load in the prepared powder detergent samples was 0.043% neat oil equivalent (NOE). Samples were prepared one day prior to the washing experiment.

### Example 16: Hand Wash Protocol of the Prepared Powder Detergent Samples Containing Microcapsules

The amount of powder detergent sample used in the hand wash experiment is determined by the amount of the wash load. Two small terry towels require five grams of powder detergent and 1 L of water. The stainless-steel wash basin was filled with water at 20° C. A proper amount of a powder detergent sample was added to the water and stirred to dissolve. The wash load contained only cotton terry towels. The towels were left to soak and then each towel was folded twice and put through the mangle. Subsequently, the wash basin was filled with clean water and towels were rinsed. Some towels were kept for damp evaluation and the rest were line dried at room temperature for dry evaluation.

### Example 17: Sensory Performance Evaluation of Microcapsules 1-14 in Powder Detergents Following Hand Wash Protocol

The fragrance intensity was evaluated by conducting a laundry experiment following the hand wash protocol described in Example 16. The randomly selected towel samples were evaluated by several experts using the intensity scale 0-5, where 0=“no performance” and 5=“strong performance”. The evaluation was performed “blind”, such that each towel sample had a randomly allocated number. The dry sensory performance evaluation was performed the day following the damp evaluation and was performed by the same experts using the same intensity scale 0-5. When evaluating “Dry pre-handling” and “Dry post-handling”, the sensory scores were recorded before and after each of the randomly selected dry towels (contained in a separate polyethylene bag) was gently handled.

The fragrance intensity was evaluated for samples at different stages of consumer laundry experience (touch points). “Pop” mimics the point of purchase. It mimics the moment a consumer opens a powder detergent product bottle in the shop to smell the fragrance. “Pop” refers to the evaluation conducted by opening and smelling the container containing the prepared powder detergent samples (containing microcapsules). “Soak” refers to the evaluation conducted by soaking the terry towels for a few minutes in the wash basin containing the powder detergent sample dissolved in water and then evaluating (smelling) the fragrance intensity buildup at the headspace of the wash basin. “Damp” refers to the evaluation of the wet towels after washing. “Dry pre-handling” refers to the evaluation of the towels after they have been line dried but before “handling”. “Dry post-handling” refers to the evaluation of the towels after they have been line dried and “handled”. The towel is “handled” by gently flicking the towel 3 times in the air, mimicking the way consumers flick their clothes after they pick them up from the line dry and before they fold them. “Bloom” refers to the evaluation of the fragrance intensity in the room where the towels are line dried. In other words, it refers to the evaluation of the release of fragrance while towels are drying in a room.

### Example 18: Analytical and Sensory Performance Data for Microcapsules 1-14

The fragrance load, PS mode and viscosity of Microcapsules 1-14 are listed in Table 14. “PS” means particle size. Dry sensory performances of Microcapsules 1-14 were evaluated. The dry sensory performances of Microcapsules 1-12 were compared with that of Microcapsules 13 and 14 respectively. “Dry sensory performance” means the sensory performance at the “Dry pre-handling” stage and the “Dry post-handling” stage. “++” means the performance is much better than that of the benchmark (Microcapsule 13 or 14); “+” means the performance is better than that of the benchmark; “=” means the performance is about same as that of the benchmark; “−” means the performance is worse than that of the benchmark; and “−−” means the performance is much worse than that of the benchmark.

As shown in Table 14, Microcapsules 1 and 7 exhibited better performance compared to Microcapsule 14, thereby demonstrating the advantage of including xyloglucan in the preparation of microcapsule. In addition, the best performances observed were those microcapsules prepared by adding xyloglucan to the emulsion within 5 minutes after commencement of the emulsification (Microcapsules 1, 5, 7, 8, and 9 compared to Microcapsules 2, 3 and 4), thereby demonstrating that the timing of xyloglucan addition is critical to the performance of the produced microcapsule.

TABLE 14
Dry Sensory Performance

| | | | | Dry Sensory | Dry Sensory |
|---|---|---|---|---|---|
| | | PS | Viscosity | Performance | Performance |
| | Fragrance | Mode | (cps; | Compared with | Compared with |
| Microcapsule | load (%) | (μm) | 21 s⁻¹) | Microcapsule 14 | Microcapsule 13 |
| 1 | 27.1 | 27.7 | 511 | ++ | = |
| 2 | 27.1 | 49.0 | 1000 | = | −− |
| 3 | 27.1 | 31.0 | 450 | = | −− |
| 4 | 27.1 | 30.0 | 420 | = | −− |
| 5 | 26.7 | 20.5 | 461 | + | − |
| 6 | 30.6 | 22.4 | 400 | + | − |
| 7 | 29.0 | 22.0 | 500 | + | − |
| 8 | 21.7 | 22.9 | 299 | ++ | = |
| 9 | 26.9 | 22.9 | 404 | ++ | = |
| 10 | 30.0 | 9.37 | 1474 | = | −− |
| 11 | 30.0 | 10.6 | 692 | + | − |
| 12 | 30.0 | 12.7 | 313 | + | − |
| 13 (Comparative | 24.7 | 5.0 | 800 | ++ | N.A.¹ |
| Microcapsule) | | | | | |
| 14 (Comparative | 31.2 | 22.0 | 450 | N.A.¹ | −− |
| Microcapsule) | | | | | |

¹N.A., not applicable.

### Example 19: Timing of XG Addition is Important for Good Dry Sensory Performance

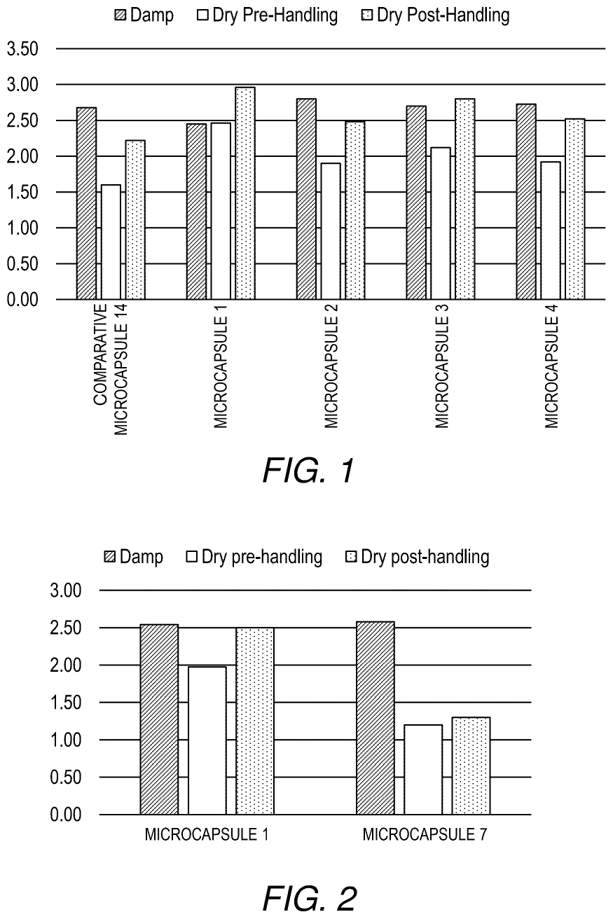

FIG. 1 shows that Microcapsule 1 outperformed Microcapsules 2, 3 and 4 at the dry stages, demonstrating that timing of xyloglucan (XG) addition is critical to the performance of the produced microcapsule and the advantage of adding xyloglucan to the emulsion within 5 minutes after commencement of the emulsification. FIG. 1 also shows that Microcapsule 1 significantly outperformed Comparative Microcapsule 14 at the dry stages, demonstrating the advantage of including xyloglucan in the preparation of microcapsule.

### Example 20: Amount of XG is Important for Good Dry Sensory Performance

FIG. 2 demonstrates that the amount of xyloglucan used in the preparation of microcapsule is important for the resulting microcapsule's good dry sensory performance. Microcapsule 1 exhibited improved dry sensory performance compared to Microcapsule 7 which was prepared with half the amount of xyloglucan used for Microcapsule 1, thereby demonstrating that xyloglucan improves wall strength of the resulting microcapsules.

### Example 21: Sensory Performance of Different Microcapsules

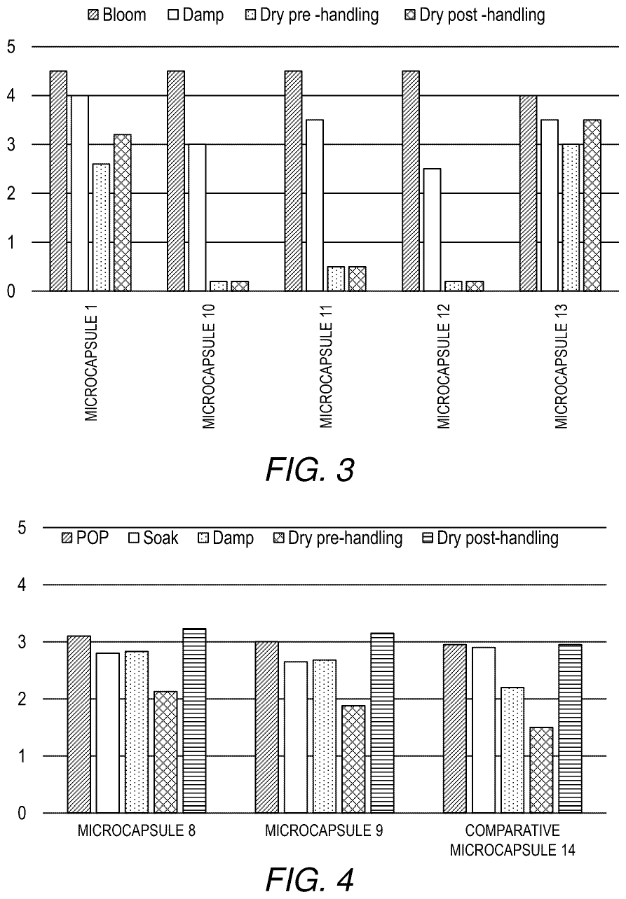

FIG. 3 shows the sensory performance of different kinds of Microcapsules sprayed to powder detergent and then used in laundry experiments following the hand wash protocol described in Example 16. Microcapsule 1 (prepared using denatured pea protein as dispersant) showed significantly better sensory performance at dry stages compared to Microcapsules 10-12 (prepared using modified starch as dispersant), and similar sensory performance compared to Microcapsule 13 (commercial melamine formaldehyde microcapsule).

### Example 22: Sensory Performance of Different Microcapsules

FIG. 4 shows the sensory performance of different kinds of Microcapsules sprayed to powder detergent and then used in laundry experiments following the hand wash protocol described in Example 16. Microcapsules 8 and 9 (comprising xyloglucan) showed better sensory performance at dry stages compared to Comparative Microcapsule 14 (no xyloglucan).

### Example 23: Microcapsule Spray Breakage Test

Microcapsule slurry was sprayed with a pressure of 1 Bar to the commercial un-fragranced OMO Red Core PWD VN powder detergent base at a dosage of 0.05% NOE. The resulting detergent was mixed for 5 minutes. Breakage percent was measured and shown in Table 15. It was found that breakage percent after spraying was reduced by including xyloglucan in the preparation of microcapsule (Microcapsules 8 and 9) when compared to Comparative Microcapsule 14 (no xyloglucan). Moreover, lowering the fragrance load (Microcapsules 8) can further reduce breakage percent.

TABLE 15
Microcapsule Breakage

| Microcapsule | Breakage % |
|---|---|
| Microcapsule 8 (lower fragrance load) | 29.50 |
| Microcapsule 9 (more TAKENATE ® D-110N) | 34.50 |
| Comparative Microcapsule 14 (no XG) | 35.00 |
| Microcapsule 13 (melamine formaldehyde) | 31.50 |

### Example 24: Mechanical Strength of the Capsules

The mechanical strength of the capsules was characterized by the micromanipulation technique described in the Section “Method for Measuring the Rupture Force” of this disclosure. Microcapsule slurry was diluted in water at 0.2% NOE of which one drop was placed on a glass slide and air dried. Dried microcapsules were aligned with the compressing probe and compressed at a speed of 2 μm per second. The rupture force, deformation and applied stress are presented in Table 16.

TABLE 16
Mechanical Strength of Capsules

| | Rupture | | |
|---|---|---|---|
| | Force | Deformation | Stress |
| Microcapsule | (μN) | % | (MPa) |
| Microcapsule 1 | 147.7 ± 37.7 | 48.4 ± 3.8 | 0.7 ± 0.2 |
| Comparative Microcapsule 14 | 89.9 ± 17.3 | 48.9 ± 3.6 | 0.4 ± 0.1 |
| Comparative Microcapsule 13 | 109.9 ± 28.5 | 32.2 ± 3.9 | 0.6 ± 0.2 |

Capsules of Microcapsule 1 exhibited the best strength in terms of rupture force. Notably, the rupture force of capsules of Microcapsule 1 was nearly double the rupture force of capsules of Comparative Microcapsule 14 (no xyloglucan) with the same deformation. Capsules of Microcapsule 1 also showed improved wall strength compared to melamine formaldehyde microcapsules (Microcapsule 13).

Every document cited herein, including any cross referenced or related patent or application and any patent application or patent to which this application claims priority or benefit thereof, is hereby incorporated herein by reference in its entirety for all purposes unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination.

1. A core-shell microcapsule slurry, comprising:
(a) a core-shell microcapsule, wherein the core-shell microcapsule has a microcapsule core and a microcapsule shell encapsulating the microcapsule core, the microcapsule core comprises an active material, and the microcapsule shell comprises a self-condensed polyisocyanate and a beta-1-4 non-ionic polysaccharide;
(b) a dispersant comprising a denatured protein, wherein the denatured protein comprises a denatured pea protein and/or a denatured whey protein; and
(c) a hydrocolloid comprising gum Arabic;
wherein the microcapsule shell is characterized by a rupture force of at least 100 μN.

2. The core-shell microcapsule slurry of claim 1, wherein the active material comprises a fragrance, a pro-fragrance, a malodor counteractive agent, or a combination thereof.

3. The core-shell microcapsule slurry of claim 1, wherein the beta-1-4 non-ionic polysaccharide is xyloglucan.

4. The core-shell microcapsule slurry of claim 3, wherein the xyloglucan is present in an amount of from 0.1 wt % to 5 wt %, or preferably from 0.1 wt % to 1 wt %, or preferably from 0.1 wt % to 0.5 wt %, relative to the weight of the core-shell microcapsule slurry.

5. The core-shell microcapsule slurry of claim 1, wherein the weight ratio of the beta-1-4 non-ionic polysaccharide to the denatured pea protein and/or the denatured whey protein is in the range of from 1:6 to 1:7.5.

6. The core-shell microcapsule slurry of claim 1, wherein the weight ratio of the beta-1-4 non-ionic polysaccharide to the microcapsule shell is in the range of from 1:3 to 1:5.

7. The core-shell microcapsule slurry of claim 1, wherein the active material is a fragrance present at a level of from 1 wt % to 35 wt % relative to the weight of the core-shell microcapsule slurry.

8. The core-shell microcapsule slurry of claim 1, wherein the active material is a fragrance present in an amount of from 0.01 wt % to 1 wt %, relative to the weight of the core-shell microcapsule slurry, and the fragrance comprises at least five High Performance fragrance ingredients comprising Ultra High-Impact fragrance ingredients as listed in Table 1, High-Impact fragrance ingredients as listed in Table 2, or combinations thereof.

9. The core-shell microcapsule slurry of claim 1, wherein the polyisocyanate is trimethylol propane-adduct of xylylene diisocyanate.

10. A process for producing a core-shell microcapsule slurry, comprising:
(a) providing an aqueous phase comprising a denatured protein and gum Arabic, wherein the denatured protein comprises a denatured pea protein and/or a denatured whey protein;
(b) providing an oil phase comprising an active material and a polyisocyanate;
(c) emulsifying the oil phase with the aqueous phase to form an emulsion;
(d) adding all of a beta-1-4 non-ionic polysaccharide to the emulsion within 5 minutes after commencement of the emulsifying step (c) to form a microcapsule slurry comprising core-shell microcapsules; and
(e) curing the shell of the microcapsules at a temperature in the range of from 40° C. to 90° C.

11. The process of claim 10, wherein the beta-1-4 non-ionic polysaccharide is xyloglucan.

12. The process of claim 10, wherein the amount of beta-1-4 non-ionic polysaccharide added to the emulsion in step (d) is in a range of from about 0.1 wt % to about 5 wt %, based on the weight of the microcapsule slurry.

13. The process of claim 10, wherein the aqueous phase further comprises tannic acid.

14. A core-shell microcapsule slurry obtainable by the process of claim 10.

15. A consumer product comprising the core-shell microcapsule slurry of claim 1, wherein the consumer product is a fabric softener, a fabric refresher, or a laundry detergent, preferably wherein the consumer product is in the form of a spray-dried powder.
